(19) United States
(12) Patent Application Publication
(10) Pub. No.: US 2025/0220582 A1
(43) Pub. Date: Jul. 3, 2025

(54) TRANSMISSION TRIGGERING USING A SEPARATE LOW-POWER WAKE-UP RECEIVER

(71) Applicant: Intel Corporation, Santa Clara, CA (US)

(72) Inventors: Yingyang Li, Santa Clara, CA (US); Yi Wang, Santa Clara, CA (US); Gang Xiong, Portland, OR (US); Debdeep Chatterjee, San Jose, CA (US); Toufiqul Islam, Santa Clara, CA (US)

(21) Appl. No.: 18/852,349

(22) PCT Filed: Jul. 13, 2023
(86) PCT No.: PCT/US2023/070107

§ 371 Date: Sep. 27, 2024

Related U.S. Application Data
(60) Provisional application No. 63/389,275, filed on Jul. 14, 2022.
(60) Provisional application No. 63/389,278, filed on Jul. 14, 2022.
(60) Provisional application No. 63/389,280, filed on Jul. 14, 2022.
(60) Provisional application No. 63/411,465, filed on Sep. 29, 2022.
(60) Provisional application No. 63/411,542, filed on Sep. 29, 2022.
(60) Provisional application No. 63/484,957, filed on Feb. 14, 2023.

(51) Int. Cl. H04W 52/02; H04W 68/02; H04W 76/27; H04W 76/28

(52) U.S. Cl. CPC H04W 52/0235; H04W 68/02; H04W 76/27; H04W 76/28

(57) ABSTRACT

Various embodiments herein provide techniques related to a main receiver of a user equipment (UE) and a wake-up receiver (WUR) of the UE. In the embodiments, the WUR receives a low-power wake-up signal (LP-WUS) from a base station. Based on the LP-WUS, the WUR may be configured to wake-up the main receiver of the UE, wherein the UE identifies received configuration information including duty cycle parameters and detects the LP-WUS based on the configuration information, and wherein the UE sets a state of the wake-up receiver based on an RRC state of the main receiver.

### CROSS REFERENCE TO RELATED APPLICATION

The present application claims priority to U.S. Provisional Patent Application No. 63/389,275, which was filed Jul. 14, 2022; 63/389,278, which was filed Jul. 14, 2022; 63/389,280, which was filed Jul. 14, 2022; 63/411,465, which was filed Sep. 29, 2022; 63/411,542, which was filed Sep. 29, 2022; and to U.S. Provisional Patent Application No. 63/484,957, which was filed Feb. 14, 2023.

### FIELD

Various embodiments generally may relate to the field of wireless communications. For example, some embodiments may relate to techniques associated with a low power wake-up receiver.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a main receiver and a wake-up receiver (which may be referred to herein as a “WUR”), in accordance with various embodiments.

FIG. 2 illustrates an example of a low-power wake-up signal (LP-WUS), in accordance with various embodiments.

FIG. 3 illustrates an example of use of a LP-WUS to indicate a user equipment (UE) for paging, in accordance with various embodiments.

FIG. 4 illustrates an example of use of a LP-WUS to indicate a group of UEs for a paging occasion, in accordance with various embodiments.

FIG. 5 illustrates an example of use of a LP-WUS in discontinuous reception (DRX) operation when a UE is in a CONNECTED state, in accordance with various embodiments.

FIG. 6 illustrates an example of continuous monitoring of a LP-WUS, in accordance with various embodiments.

FIG. 7 illustrates an example of duty cycle-based LP-WUS detection, in accordance with various embodiments.

FIG. 8 illustrates an example of multiple duty cycle configurations, in accordance with various embodiments.

FIG. 9 illustrates an example of different duty cycle configurations for different frequency ranges (FRs), in accordance with various embodiments.

FIG. 10 illustrates an example time position of a LP-WUS, in accordance with various embodiments.

FIG. 11 illustrates an alternative example time position of a LP-WUS, in accordance with various embodiments.

FIG. 12 illustrates an example of LP-WUS timing relative to the start of a DRX ON signal, in accordance with various embodiments.

FIG. 13 illustrates an alternative example of LP-WUS timing relative to the start of a DRX ON signal, in accordance with various embodiments.

FIG. 14 illustrates an alternative example of LP-WUS timing relative to the start of a DRX ON signal, in accordance with various embodiments.

FIG. 15 illustrates an alternative example of LP-WUS timing relative to the start of a DRX ON signal, in accordance with various embodiments.

FIG. 16 illustrates an example state machine of a main receiver and a low power WUR (LP-WUR), in accordance with various embodiments.

FIG. 17 shows an alternative example of an example state machine of a main receiver and a LP-WUR where the LP-WUR is fixed ON if the main receiver is in the CONNECTED state, in accordance with various embodiments.

FIG. 18 illustrates an example state machine where the LP-WUR is not applicable if the main receiver is in the CONNECTED state, in accordance with various embodiments.

FIG. 19 schematically illustrates a wireless network in accordance with various embodiments.

FIG. 20 schematically illustrates components of a wireless network in accordance with various embodiments.

FIG. 21 is a block diagram illustrating components, according to some example embodiments, able to read instructions from a machine-readable or computer-readable medium (e.g., a non-transitory machine-readable storage medium) and perform any one or more of the methodologies discussed herein.

FIG. 22 illustrates a network in accordance with various embodiments.

FIG. 23 depicts an example procedure for practicing the various embodiments discussed herein.

FIG. 24 depicts another example procedure for practicing the various embodiments discussed herein.

FIG. 25 depicts another example procedure for practicing the various embodiments discussed herein.

FIG. 26 depicts another example procedure for practicing the various embodiments discussed herein.

FIG. 27 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Fifth generation (5G) systems may be designed and developed targeting for one or both of mobile telephony and vertical use cases. Besides latency, reliability, and availability, user equipment (UE) energy efficiency may also be considered to be critical to 5G. Existing 5G devices may have to be recharged per week or day, depending on an individual's usage time. In general, 5G devices consume tens of milliwatts in the radio resource control (RRC) idle/inactive state, and hundreds of milliwatts in the RRC connected state. Designs to prolong battery life may improve energy efficiency and/or provide for better user experience.

The power consumption depends on the configured length of wake-up periods, e.g., paging cycle. To meet the battery life requirements above, long discontinuous reception (DRX) cycle is expected to be used, resulting in high latency, which may not be suitable for such services with requirements of both long battery life and low latency. For example, in fire detection and extinguishment use case, fire shutters may be required to be closed and fire sprinklers shall be turned on by the actuators within 1 to 2 seconds from the time the fire is detected by sensors. A long DRX cycle may not be able to meet the delay requirements. Therefore, it may be desirable to reduce the power consumption with a reasonable latency.

In legacy implementations, UEs may need to periodically wake up once per DRX cycle, which may dominate the power consumption in periods with no signalling or data traffic. If UEs are able to wake up only when they are triggered, e.g., paging, power consumption may be dramatically reduced. Such reduction may be achievable by using a wake-up signal (WUS) to trigger the main radio. The WUS may be received by a separate receiver that has the ability to monitor for the WUS with ultra-low power consumption. Such a receiver may be referred to herein as a WUR or a low power WUR (LP-WUR). The UE's main receiver may work for data transmission and reception, and it may be turned off or set to deep sleep unless it is turned on (e.g., via receipt of a WUS).

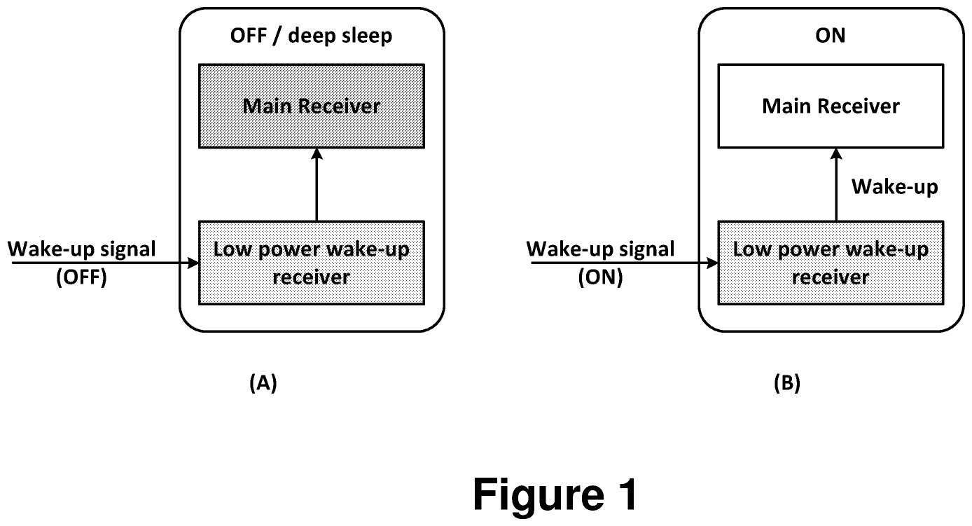

FIG. 1 illustrates one example for the use of main receiver and a WUR. In the power saving state, if no WUS is received by the WUR, the main receiver may stay in the OFF state for deep sleep. On the other hand, if a WUS is received by the WUR, the WUR may trigger to turn on the main receiver. In the latter case, because the main receiver is active, the WUR can be turned off.

The power consumption for monitoring for a WUS may depend on the WUS design and the hardware module of the WUR used for signal detecting and processing. In this disclosure, example basic designs on the procedure for the wake-up signal/channel transmission are disclosed. In particular, embodiments may relate to one or more of:
Discontinuous reception (DRX) in an IDLE/INACTIVE state (e.g., a RRC IDLE or INACTIVE state);
DRX in a CONNECTED state (e.g., a RRC CONNECTED state); and/or
Continuous LP-WUS monitoring in sCONNECTED state

DRX in IDLE/INACTIVE State

For the DRX operation in IDLE/INACTIVE state of a UE in accordance with the third generation partnership project (3GPP) new radio (NR) Release-17 (Rel-17) specifications, a permanent equipment identifier (PEI) physical downlink control channel (PDCCH), e.g., downlink control information (DCI) format 2_7 is introduced which indicates whether a sub-group in a paging group of UEs is to be paged in the coming paging occasion(s). Further, the PEI PDCCH can also indicate a tracking reference signal (TRS) availability indication for IDLE/INACTIVE state. However, the decoding of PEI PDCCH requires to detect at least a system synchronization block (SSB) or a TRS for IDLE/INACTIVE state for automatic gain control (AGC) and time/frequency synchronization. The UE may need to do radio resource management (RRM) measurement based on the SSB too. In summary, in each paging cycle, the UE still needs to detect a least a SSB or TRS for IDLE/INACTIVE state and detect a PEI PDCCH, which still consume much power. To further reduce the power consumption, a separate low-power wake-up receiver (LP-WUR) can be used to detect a low-power wake-up signal (LP-WUS) and the main receiver is only active when a LP-WUS is detected. Here, by TRS, periodic TRS configured in idle/inactive mode is assumed.

LP-WUS can serve at least one of the following purposes:
LP-WUS can be used for cell selection, e.g., UE may identify the cell and perform RRM measurement based on LP-WUS.
LP-WUS can be used to determine paging reception.
LP-WUS can be used to determine system information block (SIB) reception.
LP-WUS can be used to obtain synchronization

To serve corresponding purposes, single or multiple different type of LP-WUS can be supported.

For example, for all purposes, a single LP-WUS configuration may be applied. For another example, multiple different types of LP-WUS can be configured to serve different purposes, e.g., to enable RRM measurement, a first type of LP-WUS is transmitted periodically, which carries information to identify the cell, e.g., cell identifier (ID), and a second type of LP-WUS is transmitted aperiodically, which wakes up the UE to receive other DL channel/signals or transmit UL channel/signals. The second type of LP-WUS may be still configured with periodicity, however, the gNB only transmits a LP-WUS on demand. To receive first and second type LP-WUS, the UE does not need to turn on the main radio, and UE turns on the main radio only if UE detects certain type of LP-WUS indicating the UE to turn on the main radio, e.g., second type LP-WUS indicates paging reception for the UE.

UE may receive one type of LP-WUS depending on the reception of another type of LP-WUS. For example, UE receives other type LP-WUS only if UE can receive first type LP-WUS with RRM result larger than a threshold.

UE may receive one type of LP-WUS according to configuration or condition. For example, if the RRM result based on legacy procedure (by synchronization signal (SS)/physical broadcast channel (PBCH) or channel state information reference signal (CSI-RS)) or based on first type LP-WUS is larger than certain threshold, or the difference between last and current RRM result is no larger than certain threshold, UE can receive second type of LP-WUS, otherwise, UE skips reception of the second type of LP-WUS. Instead, UE may need to turn on the main radio to perform corresponding reception, e.g., legacy paging reception.

In the following embodiments, a LP-WUS may include one or more parts. For example, a LP-WUS may include two parts wherein the first part is for a sequence for LP-WUS detection, and the second part is with payload, e.g., UE sub-group information and/or other downlink (DL) channel/signal reception indication. For example, for a LP-WUS with only single part, the LP-WUS may be generated by a sequence or by encoding the payload information. For example, if the first part is detected with an energy or power level higher than a threshold, the UE may further detect the second part. In other words, the first part is an indicator on whether the second part is transmitted or not.

In one example, the first type of LP-WUS may be sequence based while the second type of LP-WUS can encode and transmit the payload information. The first type of LP-WUS can be used for synchronization and measurement purpose, e.g., for RRM measurement. Then, the second type of LP-WUS can be processed based on the detected first type of LP-WUS. The second type of LP-WUS can carry the wake-up information. In some embodiments, the second type of LP-WUS may also be used for measurement purpose.

In another example, the first type of LP-WUS may be sequence based while the second type of LP-WUS may include two parts. The first type of LP-WUS may be used for synchronization and RRM purpose. Then, the second type of LP-WUS may be processed based on the detected first type of LP-WUS. The second type of LP-WUS may carry the wake-up information. The second type of LP-WUS may be used for RRM purpose too.

In one embodiment, if the RRM measurement is still valid for a UE which indicates the UE is still in the current cell, the UE can monitor the LP-WUS to determine if the UE needs to wake up the main receiver in a paging cycle. Once the main receiver is turned on in the paging cycle, it may be up to UE implementation to redo RRM measurement based on e.g., the detected SSB or CSI-RS. On the other hand, if the RRM measurement become invalid, the UE may not detect the configured LP-WUS. Therefore, the UE may perform RRM measurement, detect PEI PDCCH, and/or detect a paging PDSCH according to one or more legacy 3GPP procedures.

In one option, the UE may perform the RRM measurement based on legacy NR reference signals, e.g., UE turns on the main radio to receive SS/PBCH. If RRM measurement triggers cell re-selection, the UE may begin an initial access process for a new cell according to legacy process. During cell re-selection, UE may be able to skip one or more LP-WUS occasions. After UE finishes cell re-selection, or if RRM measurement does not trigger cell re-selection, UE monitor the sub-sequent LP-WUS within certain period, e.g., several paging cycles with the assumption that the selected cell would not change after last RRM measurement.

In another option, UE may perform RRM measurement based on first type LP-WUS, which may not require turning on the main radio. If RRM measurement triggers cell re-selection, UE may try to perform cell re-selection based on the first type LP-WUS for other cells. During cell re-selection, UE may skip certain LP WUS occasions, e.g., the LP WUS occasion for second type LP WUS. After UE finishes cell re-selection, or if RRM measurement does not trigger cell re-selection, UE may monitor the sub-sequent LP-WUS within certain period, e.g., monitor second type LP-WUS.

In another option, UE can perform RRM measurement based on LP-WUS and legacy NR reference signals. UE may first perform RRM measurement based on LP-WUS. If RRM measurement based on the LP-WUS triggers cell re-selection, UE can turn on the main radio and begin initial access process for new cell according to legacy process (e.g., based on SS/PBCH). During cell re-selection, UE can skip the LP WUS occasions. If RRM measurement based on the LP-WUS does not trigger cell re-selection, or after UE finishes cell re-selection by legacy procedure, UE may monitor the sub-sequent LP-WUS within certain period with the assumption that the selected cell would not change after last RRM measurement.

In one embodiment, multiple options can be considered to do RRM measurement by a LP-WUS. A UE may derive an RRM measurement only based on the first part of the LP-WUS. Alternatively, a UE may derive an RRM measurement only based on the second part of the LP-WUS. Alternatively, a UE may derive an RRM measurement based on both the first and the second part of the LP-WUS.

In one option, a UE may do the RRM measurement based on only a LP-WUS that is transmitted to the UE. The second part of the LP-WUS may include a group ID, sub-group ID or unicast ID for the UE.

In another option, a UE may do the RRM measurement based on a LP-WUS no matter the LP-WUS is indicated to the UE or not. For example, when the LP-WUS is for other UE, the UE can still receive the WUS symbols of the LP-WUS and derive the RRM measurement. However, the UE will not wake up the main radio since the LP-WUS is not for the UE.

In another option, a special LP-WUS may be transmitted by a base station such as a gNodeB (gNB). The special LP-WUS may indicate that the UE is to perform RRM measurement based on the LP-WUS. Specifically, this special LP-WUS may have a same structure as other LP-WUS, but the second part of the LP-WUS may carry a broadcast ID which indicates this LP-WUS is for RRM measurement. Alternatively, this special LP-WUS may use a specific resource which is different from other LP-WUS, e.g., a sequence different from other LP-WUS. Other functionality is not precluded for the special LP-WUS. The special LP-WUS may be transmitted with a predefined, preconfigured or a high layer configured periodicity.

In one embodiment, for RRM measurement by the LP-WUS, UE may expect that at least one LP-WUS is available for RRM measurement in a period.

In one option, UE may expect that the above special LP-WUS is transmitted by gNB periodically, which are then used for RRM measurement.

In another option, assuming UE support RRM based on a LP-WUS other than the above special LP-WUS, if gNB transmits a LP-WUS to one or more UEs in a period, gNB may not need to transmit the special LP-WUS. In other words, when gNB doesn't transmit any other LP-WUS in a period, gNB can transmit the special LP-WUS so that the UE can perform at least one RRM within a period.

In one embodiment, the LP-WUS may be configured for a UE which provides some or all functionality of PEI PDCCH defined in Rel-17. In one example, it is not precluded that LP-WUS can indicate more information than that provided by PEI PDCCH.

In one option, the early indication of the sub-groups of paging occasions and/or the TRS availability indication as defined for downlink control information (DCI) format 2_7 can be indicated by the LP-WUS. For example,
Paging indication field−N_{PO}^{PEI} N_{SG}^{PO} bit(s), where
N_{PO}^{PEI} is the number of paging occasions configured by higher layer parameter PONumPerPEI as defined in Clause 10.4A in the third generation partnership project (3GPP) technical specification (TS) 38.213;
N_{SG}^{PO} is the number of sub-groups of a paging occasion configured by higher layer parameter subgroupsNumPerPO.
Each bit in the field indicates one UE subgroup of a paging occasion.
TRS availability indication—1, 2, 3, 4, 5, or 6 bits, where the number of bits is equal to one plus the highest value of all the indBitID(s) provided by the TRS-ResourceSetConfig if configured; 0 bits otherwise.

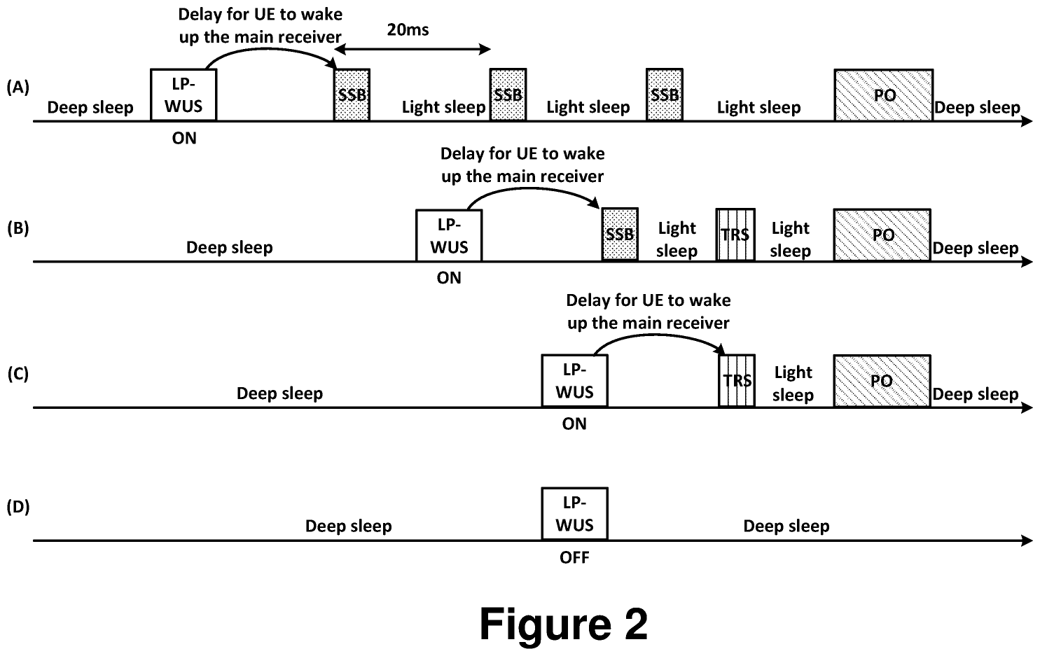

FIG. 2 illustrates one example of use of a LP-WUS to indicate paging early indication and the TRS availability indication.
In FIG. 2, part (A), the UE detects a valid indication of the LP-WUS (ON) that the paging sub-group for the UE is triggered. Then, the UE can wake up the main receiver for the detection in the associated paging occasion (PO). It is assumed that no TRS for IDLE/INACTIVE state is available, then the UE may need to detect one or more (In FIG. 2, part (A), 3 SSBs are assumed) SSBs for serving cell RRM measurements and/or fine time/frequency synchronization which are required prior to the reception of paging PDSCH.
In FIG. 2, part (B), one difference from FIG. 2, part (A) is the availability of TRS for IDLE/INACTIVE state. After the main receiver is turned on, UE may detect one SSB for RRM and one additional TRS for fine time/frequency synchronization for the reception of paging PDSCH.
In FIG. 2, part (C), one difference from FIG. 2, part (B) may be based on an assumption that no RRM is necessary in the current paging cycle. After the main receiver is turned on, UE may detect only the TRS for fine time/frequency synchronization for the reception of paging PDSCH.
In FIG. 2, part (D), the UE detects a LP-WUS (OFF) that indicates the paging sub-group for the UE is not triggered. If the UE doesn't need to do RRM measurement in the current paging cycle, the UE will not wake up the main receiver at all. Alternatively, if the LP-WUS can be used for RRM, the UE may determine a RRM measurement and will not wake up the main receiver at all.

In one embodiment, the LP-WUS may be configured for a UE which provides part of the functionality of PEI PDCCH defined in Rel-17. It is not precluded that LP-WUS can indicate more information than that provided by PEI PDCCH.

In one option, the early indication for a UE to be paged and/or the TRS availability indication as defined for DCI format 2_7 can be indicated by the LP-WUS. For example,
Paging indication field—the ID of a UE to be paged.
TRS availability indication−1, 2, 3, 4, 5, or 6 bits, where the number of bits is equal to one plus the highest value of all the indBitID(s) provided by the TRS-ResourceSetConfig if configured; 0 bits otherwise.

In this option, the LP-WUS may also indicate the intended operation for the paged UE. For example, short message indication with or without short message can be indicated by LP-WUS. Consequently, once the UE knows it is paged by the LP-WUS, the UE may start reception of other control/data when the UE is ready to receive the control/data, irrespective of the relative timing between the PO and the timing of the other control/data. For example, UE may start monitoring of system information update even if the system information update is earlier than the PO or Message 2 or Message B reception pursuant to physical random access channel (PRACH) transmission from the main radio.

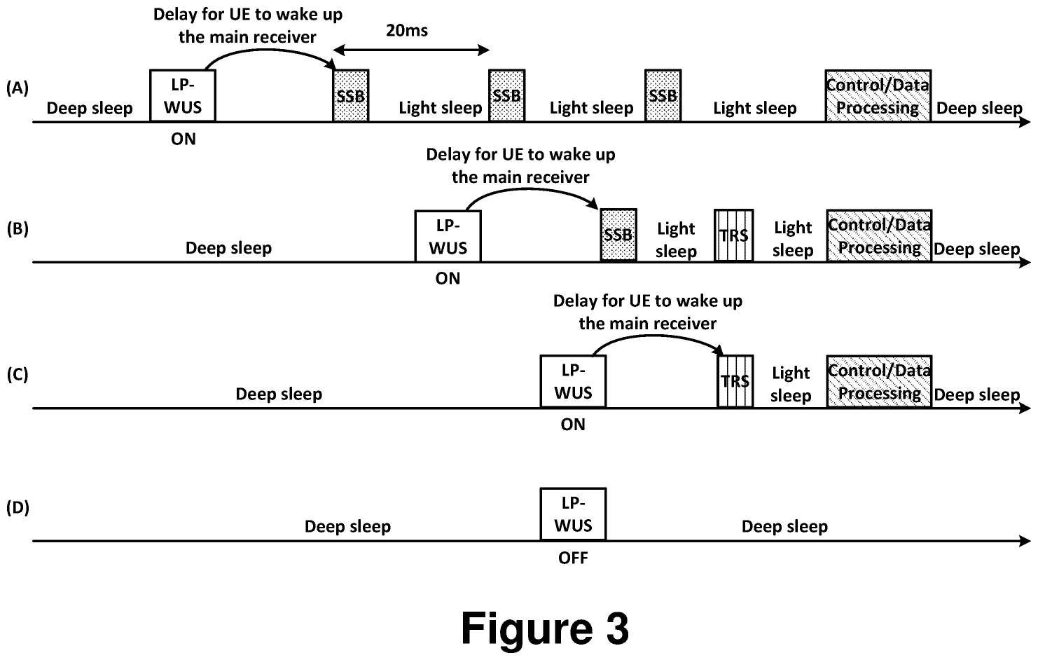

FIG. 3 illustrates examples of use of the LP-WUS to indicate a specific UE to be paged and the TRS availability indication. Since the paged UE may already be indicated by the LP-WUS, the UE may not need to monitor the PO again. The UE may turn on the main receiver for other control/data reception if the UE is paged.
In FIG. 3, part (A), if the LP-WUS (ON) indicates that the UE is paged, the UE can wake up the main receiver. It is assumed that no TRS for IDLE/INACTIVE state is available, then the UE may need to detect 3 SSBs for the RRM and the fine time/frequency synchronization which is required for the reception of control/data. For example, the control/data may mean control/data that are related to system information update or Message 2 or Message B reception pursuant to PRACH transmission from the main radio.
In FIG. 3, part (B), a difference from FIG. 3, part (A) is the availability of TRS for IDLE/INACTIVE state. After the main receiver is turned on, UE may detect one SSB for RRM and one additional TRS for fine time/frequency synchronization for the reception of the control/data.
In FIG. 3, part (C), a difference from FIG. 3, part (B) may be based on the assumption that no RRM is necessary in the current paging cycle. After the main receiver is turned on, UE may detect only the TRS for fine time/frequency synchronization for the reception of the control/data.
In FIG. 3, part (D), the UE detects a LP-WUS (OFF) that indicates the UE is not paged. If the UE doesn't need to do RRM measurement in the current paging cycle, the UE will not wake up the main receiver at all. Alternatively, if the LP-WUS can be used for RRM, the UE may determine a RRM measurement and will not wake up the main receiver at all.

In another option, the LP-WUS may indicate that the group of UEs of a PO is paged, and/or TRS availability indication as defined for DCI format 2_7. Since LP-WUS may indicate the group is paged, the UE may be configured to monitor PEI PDCCH to know the paged sub-group of the PO if PEI and paging sub-grouping is configured. For example,
Paging indication field−N_{PO}^{PEI} bit(s), where
N_{PO}^{PEI} is the number of paging occasions configured by higher layer parameter PONumPerPEI as defined in Clause 10.4A in [5, TS 38.213];

TRS availability indication-1, 2, 3, 4, 5, or 6 bits, where the number of bits is equal to one plus the highest value of all the indBitID(s) provided by the TRS-ResourceSetConfig if configured; 0 bits otherwise.

In this option, the LP-WUS may only include one bit to indicate if any of the associated POs are paged if the information carried by LP-WUS is to be minimized.

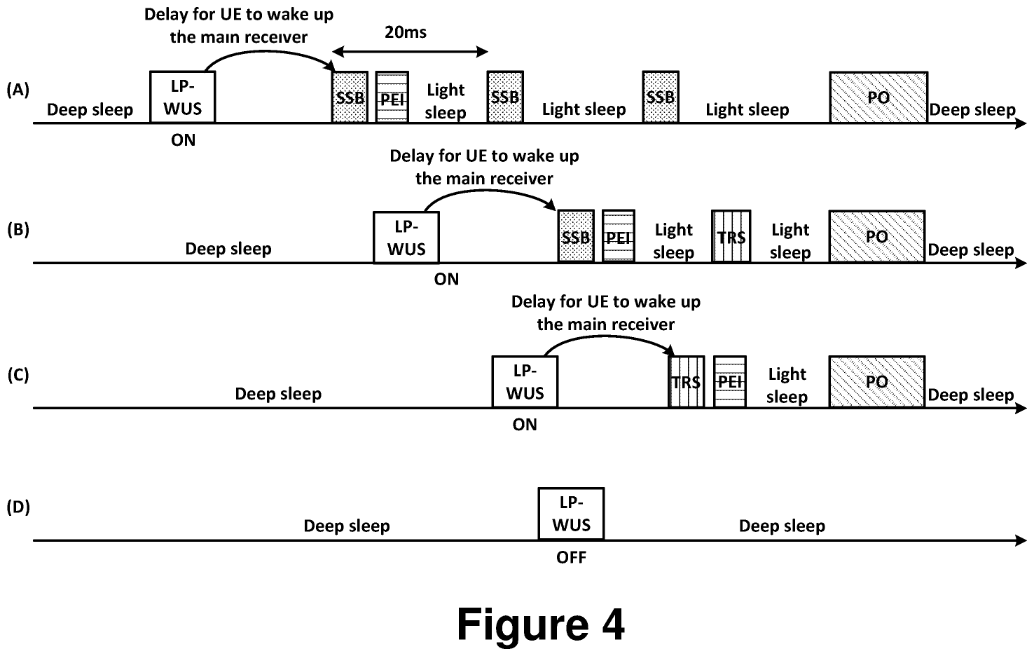

FIG. 4 illustrates an example of use of a LP-WUS to indicate paging early indication and the TRS availability indication.
In FIG. 4, part (A), the UE detects a valid indication of the LP-WUS (ON) that the paging group of a PO is paged. Then, the UE can wake up the main receiver for the detection of PDCCH PEI to know the paged sub-group. It is assumed that no TRS for IDLE/INACTIVE state is available, then the UE may need to detect 3 SSBs for the RRM, PEI PDCCH detection and the fine time/frequency synchronization which is required for the reception of paging PDSCH.
In FIG. 4, part (B), a difference from FIG. 4, part (A) is the availability of TRS for IDLE/INACTIVE state. After the main receiver is turned on, UE may detect one SSB for RRM and PEI PDCCH detection, and one additional TRS for fine time/frequency synchronization for the reception of paging PDSCH.
In FIG. 4, part (C), a difference from FIG. 4, part (B) may be that there is no assumption that RRM is necessary in the current paging cycle. After the main receiver is turned on, UE may detect only the TRS for fine time/frequency synchronization for the reception of PEI PDCCH and paging PDSCH.
In FIG. 4, part (D), the UE may detect a LP-WUS (OFF) that indicates the paging group for the UE is not paged. If the UE doesn't need to do RRM measurement in the current paging cycle, the UE will not wake up the main receiver at all. Alternatively, if the LP-WUS can be used for RRM, the UE may determine a RRM measurement and will not wake up the main receiver at all.

For the above embodiments, the LP-WUS may be configured to indicate some or all of the following information. It is not precluded that LP-WUS can indicate more information than that provided by PEI PDCCH.
Paging early indication which may indicate the group of UEs for a PO, a sub-group of the group of UEs for a PO, or a UE to be paged.
TRS for idle/inactive indication, which may be defined as in DCI format 2_7
Other control/data reception indication

For example, LP WUS may indicate whether to receive paging PDCCH/PDSCH after turning the main receiver. Similar to Short Messages Indicator and/or Short Message defined in DCI format 1_0 in Type2 CSS set, e.g., Table 7.3.1.2.1-1 in 3GPP TS 38.212 and Table 6.5-1 in 3GPP TS 38.331, LP WUS can indicate which control/data channel is to be received after turning on the main receiver. Table 1 and table 2 provide two examples.

TABLE 73.1.2.1-1
Short Message indicator

| Bit | |
|---|---|
| field | Short Message indicator |
| 00 | Reserved |
| 01 | Only scheduling information for Paging is present in the |
| | DCI |
| 10 | Only short message is present in the DCI |
| 11 | Both scheduling information for Paging and short message |
| | are present in the DCI |

TABLE 65-1
Short Messages

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum |
| | channel access and if |
| | nrofPDCCH-MonitoringOccasionPerSSB-InPO is present. |
| | If set to 1: indication that the UE may stop monitoring PDCCH |
| | occasion(s) for paging in this Paging Occasion as specified in |
| | TS 38.304 [20], clause 7.1. |
| 4-8 | Not used in this release of the specification, and shall be ignored |
| | by UE if received. |

TABLE 1
Other control/data reception indication with 1 bit

| Bit | |
|---|---|
| value | Expected UE behaviour after reception of LP-WUS |
| 0 | Monitor PDCCH/PDSCH in subsequent paging occasion |
| 1 | Receive system information (systemInfoModification) |

TABLE 2
Other control/data reception indication with 2 bits

| Bit | |
|---|---|
| value | Expected UE behaviour after reception of LP-WUS |
| 00 | Monitor PDCCH/PDSCH in subsequent paging occasion |
| 01 | Receive system information (systemInfoModification) |
| 10 | Receive notification (etwsAndCmasIndication) |
| 11 | Perform legacy initial access |

In one embodiment, if a UE detects a valid LP-WUS (ON) for the UE, the UE may or may not turn on the main receiver according to the indication of the LP-WUS. The detected valid LP-WUS can indicate whether to wake up the main receiver or not for the UE. Otherwise, if the UE does not detect a valid LP-WUS, one from the following options may be considered.

In one option, gNB transmits LP-WUS to a UE or a group/subgroup of UE, if gNB expects the UEs to turn on the main receiver. If the UE does not detect the LP-WUS which targets the UE, the UE may not turn on the main receiver. This is most power efficient for the UE.

In another option, gNB transmits LP-WUS to a UE or a group/subgroup of UE with the information of whether or not the UEs should turn on the main receiver. For example, 1 bit in LP-WUS indicates whether to turn on the main receiver, if the UE does not detect a LP-WUS which indicates the UE to wake up the main receiver, the UE turns on the main receiver to receive legacy DL signals/channels, e.g., monitor PEI and/or PO according to a legacy procedure. In this way, if UE missed the LP-WUS from gNB, UE could still receive the paging.

### DRX in CONNECTED State

For the DRX operation in CONNECTED state of a UE operating in a network that is in accordance with the 3GPP NR Release-16 (Rel-16) sp[ecifications, a DCI format, e.g., DCI format 2_6 is introduced which indicates that the UE should wake up for PDCCH monitoring in the DRX ON duration. Further, the DCI format 2_6 can also indicate up to 5 bits for SCell dormancy switching.

In one embodiment, for UE in CONNETCTED state, the LP-WUS may be configured for a UE to indicate whether to turn on the main receiver in a period. For example, LP-WUS occasion is configured with periodicity. Within a period, LP-WUS indicates whether to turn on the main receiver.

In one embodiment, the LP-WUS may be configured for a UE to indicate control/data reception in the next DRX ON duration for a UE, e.g., whether to skip PDCCH monitoring in UE-specific Search spacing in the next DRX ON duration, while the UE behavior in DRX off period is same as legacy operation. The LP-WUS may only indicate one bit for wake-up indication. The LP-WUS may only indicate one or more bits SCell dormancy indication. Alternatively, the LP-WUS may include one bit for wake-up indication and one or more bits SCell dormancy indication. It is not precluded that LP-WUS can indicate more information than that provided by DCI format 2_6. There is a delay between the LP-WUS and the time that UE is ready for reception in the DRX ON duration, which can be predefined, configured by high layer or determined by a UE capability report.

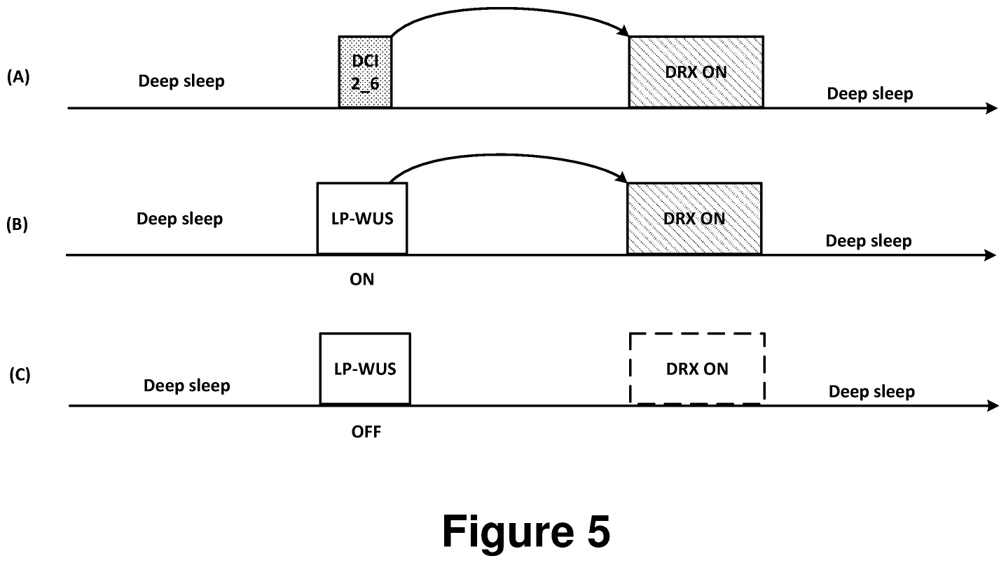

FIG. 5, parts (A)-(C) illustrate examples related to the indication of control/data transmission in DRX ON duration by existing DCI format 2_6 in NR or LP-WUS.
FIG. 5, part (A) depicts an example of legacy behavior wherein a UE can be configured to monitor the corresponding bit(s) in DCI format 2_6 to know if the UE has a control/data transmission in the DRX ON duration on the PCell or SCell(s).
In FIG. 5, part (B), the UE may detect a valid indication of the LP-WUS (ON) for the control/data reception in the next DRX ON duration. The UE can wake up the main receiver for the detection of control/data transmission in DRX ON duration. The power consumption to monitor LP-WUS is much lower than the DCI format 2_6.
In FIG. 5, part (C), it is assumed that the UE doesn't detect a LP-WUS (OFF) for the control/data reception in the next DRX ON duration, the UE may not wake up the main receiver.

Note: In FIG. 5 parts (A) or (B), the UE may already have valid AGC, time/frequency synchronization, hence UE may directly receive the control/data transmission in the DRX ON duration. Alternatively, LP WUS can also indicate whether any signal/channel is to be received before the DRX ON duration, e.g., aperiodic TRS. Then, UE should turn on the main receiver before such signal/channel, and then UE can setup AGC and/or perform time/frequency synchronization before the DRX ON duration.

In one embodiment, the LP-WUS may be configured for a UE to indicate control/data reception in the next DRX ON duration for a UE, and whether to receive certain signals in DRX off period.

In one option, LP-WUS can indicate UE may turn off the main receiver in DRX on and/or off period within a LP-WUS period.

In another option, LP-WUS can indicate UE to skip the reception of any control/data in DRX on and/or off period within a LP-WUS period.

In another option, LP-WUS can indicate UE to skip the reception of certain control/data in DRX on and/or off period within a LP-WUS period. The certain control/data can be at least one of UE-specific higher-layer configured DL or UL control/data, cell-specific DL or UL control/data, cell-specific reference signal, reference signal other than RS for certain purpose, e.g., for RRM measurement.

### LP-WUS Monitoring in CONNECTED State

In one embodiment, the LP-WUS may be applicable in at least DRX ON duration or when DRX operation is not configured. The UE may continuously monitor the LP-WUS or monitor LP-WUS with a short cycle. If a LP-WUS is detected which indicates that control/data for the UE will be scheduled, the UE can turn on the main receiver for the reception of the control/data. Note: In CONNECTED state, the UE may already have valid AGC, time/frequency synchronization, hence UE may directly receive the control/data transmission by the main receiver after waking up. If not, UE needs to detect certain DL channels/signals with the main receiver to setup AGC and/or time/frequency synchronization. There is a delay between the LP-WUS and the time that UE is ready for reception using main radio, which can be predefined, configured by high layer or determined by a UE capability report.

The LP-WUS may only indicate one bit for wake-up indication. The LP-WUS may only indicate one or more bits SCell dormancy indication. Alternatively, the LP-WUS may include one bit for wake-up indication and one or more bits secondary cell (SCell) dormancy indication. It is not precluded that LP-WUS can indicate more information than that provided by DCI format 2_6.

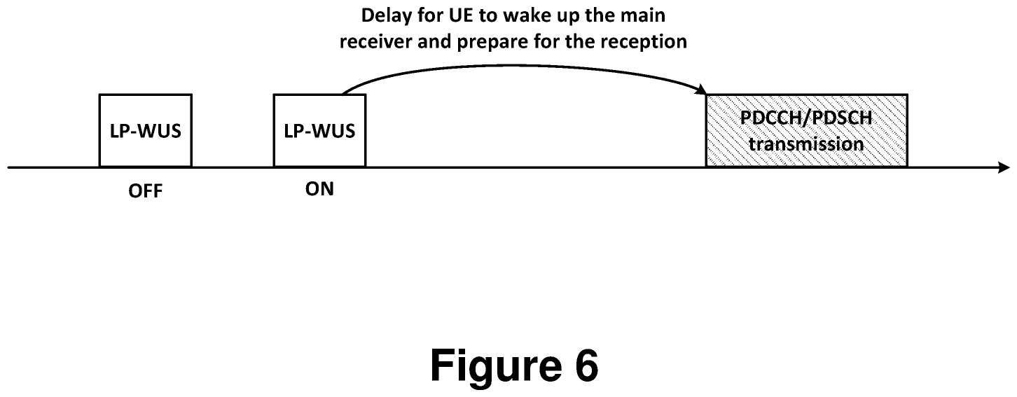

FIG. 6 illustrates an example of the continuous LP-WUS monitoring.
If the UE doesn't detect a LP-WUS (OFF) which indicate the control/data reception is to be scheduled, the UE may not wake up the main receiver.
If the UE detects a valid indication of the LP-WUS (ON) which indicates the control/data reception is to be scheduled, the UE can wake up the main receiver for the reception.

The LP-WUS may be configured for a UE to indicate the information on PDCCH skipping or search space set group (SSSG) switching. For example, the UE can be configured to detect LP-WUS instead of monitoring DCI format 0_1, 0_2, 1_1, 1_2 for PDCCH skipping or SSSG switching.

The LP-WUS may indicate the same set of information for LP-WUS in DRX OFF or in DRX ON duration. Alternatively, some information carried by the LP-WUS may be different for LP-WUS configured in DRX OFF or in DRX ON duration.

### Duty Cycle for LP-WUS

In some embodiments, the power consumption related to monitoring for a WUS may depend on the WUS design and the hardware module of the WUR used for signal detecting and processing. In this section, some basic designs on the procedure for the wake-up signal/channel transmission are discussed. In particular, embodiments may relate to one or more of the following:
Configured Duty cycle for LP-WUS
LP-WUS Determined by DRX of Other Channel/Signals

The separate LP-WUR may have the advantage of extreme low power consumption. On the other hand, it is still beneficial to consider duty cycle based operation for the LP-WUR. In such case, the LP-WUR only needs to be active in the period that a LP-WUS may be transmitted to the UE.

In one embodiment, the parameters for duty cycle based operation of LP-WUS can be configured in accordance with the timing of the main receiver. One or more of the following parameters can be used for the configuration
A duty cycle period, which is denoted as wus-Cycle
A start offset for LP-WUS detection in a duty cycle, which is denoted as wus-StartOffset
A duration in which the UE may detect LP-WUS, which is denoted as wus-OnDuration

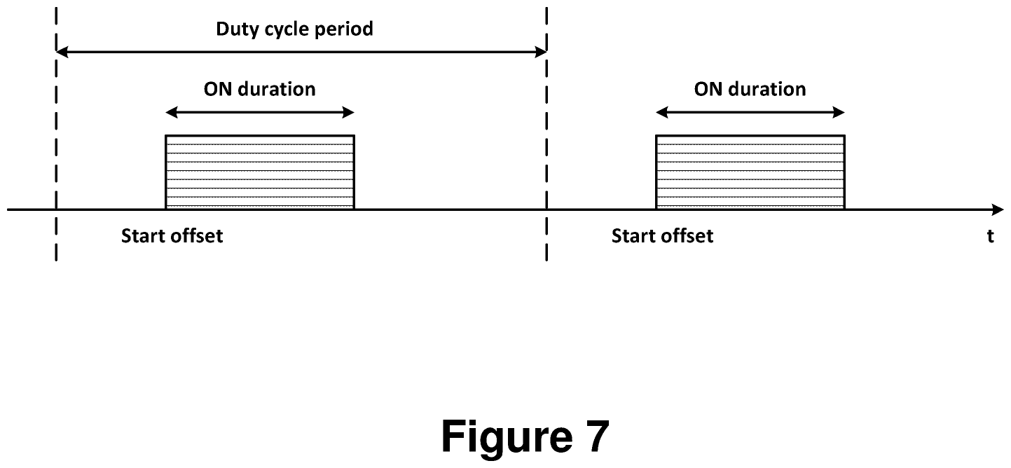

FIG. 7 illustrates an example of duty cycle based LP-WUS detection. The starting subframe for LP-WUS detection can be defined as,

[(SFN×10)+subframe number]modulo (wus-Cycle)=wus-StartOffset

Where SFN and subframe number can be derived from the main receiver.

In one option, the above start offset indicating ON duration for LP-WUS detection can be configured in unit of subframe (a subframe is fixed to 1 ms in NR). Alternatively, the start offset can be configuration in unit of slot. The slot could be a slot with a SCS numerology uₘ which is determined by the main receiver. uₘ could be the SCS of the active DL BWP of the main receiver, or the SCS of the initial DL BWP of the main receiver, or a reference SCS of the main receiver. The slot could be a slot with a SCS numerology u of the LP-WUS.

In one option, a UE may expect the LP-WUS for the UE right start from the above start offset. Correspondingly, the parameter wus-OnDuration is not necessary if UE only monitor one LP-WUS in a duty cycle. Alternatively, multiple candidate locations for the LP-WUS for the UE may be allowed. In this case, UE has to do detection for the LP-WUS in the wus-OnDuration. The candidate locations within the wus-OnDuration can be configured by a list of starting point and duration, similar to multiple SLIVs, which can support non-continuous LP-WUS locations. Alternatively, the candidate locations within the wus-OnDuration can be determined by the number of candidate locations or the duration for a LP-WUS, which can support continuous LP-WUS locations.

In another embodiment, multiple duty cycle configurations may be configured for a UE for LP-WUS detection. Each duty cycle configuration may be configured with separate wus-Cycle, wus-StartOffset and wus-OnDuration. In this option, a duty cycle configuration may be configured to allow the LP-WUS for the UE to be transmitted in a most proper time considering the wake-up delay between the LP-WUS and a desired channel/signal of the main receiver.

UE may skip a LP-WUS occasion, if UE already starts to turn on the main receiver based on a previous LP-WUS. Alternatively, UE still receives LP-WUS, if the LP-WUS and the previously detected LP-WUS is from different LP-WUS duty cycle configuration.

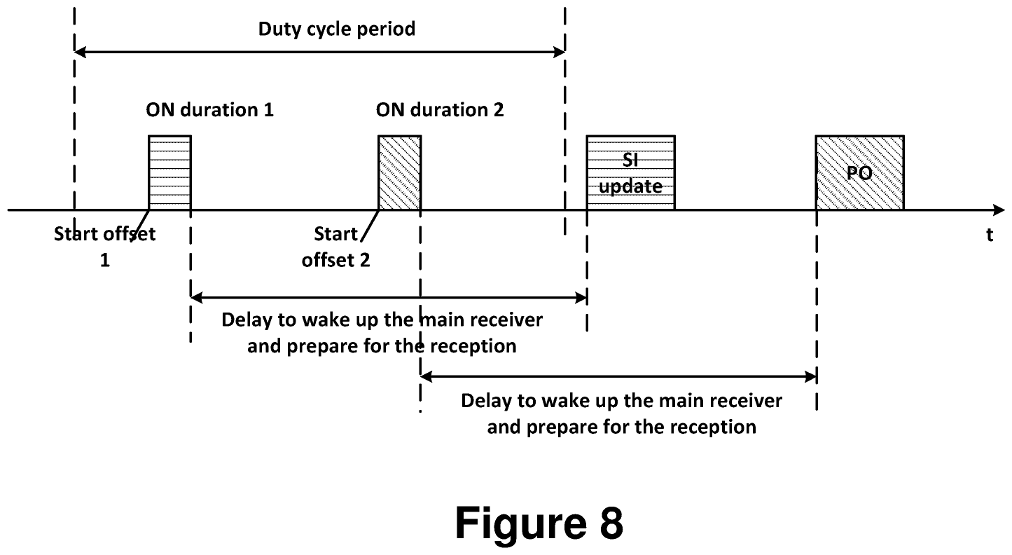

FIG. 8 illustrates an example configuration of two duty cycles for LP-WUS detection. The main receiver may be woken up for system information update or monitoring paging occasions. The PDCCH scheduling SI update and the PDCCH scheduling paging PDSCH may be configured in different timing. Assuming a fixed delay for the main receiver to wake up and receive the SI update or paging PDSCH, UE may need to monitor LP-WUS in different timing for the two kinds of transmission on main receiver. In FIG. 8, for simplicity, it is assumed that the two configuration has the same duty cycle period. However, different start offsets e.g. start offset 1 and start offset 2 may be configured for the two configurations respectively considering the timing difference between the time for SI update and PO.

In one example, if UE receives LP-WUS in ON duration 1 which indicates UE to receive SI update, UE can skip LP-WUS reception in ON duration 2. In another example, even if UE receives LP-WUS in ON duration 1, UE still tries to receive LP-WUS in On duration 2, because these two LP-WUS may indicate different information.

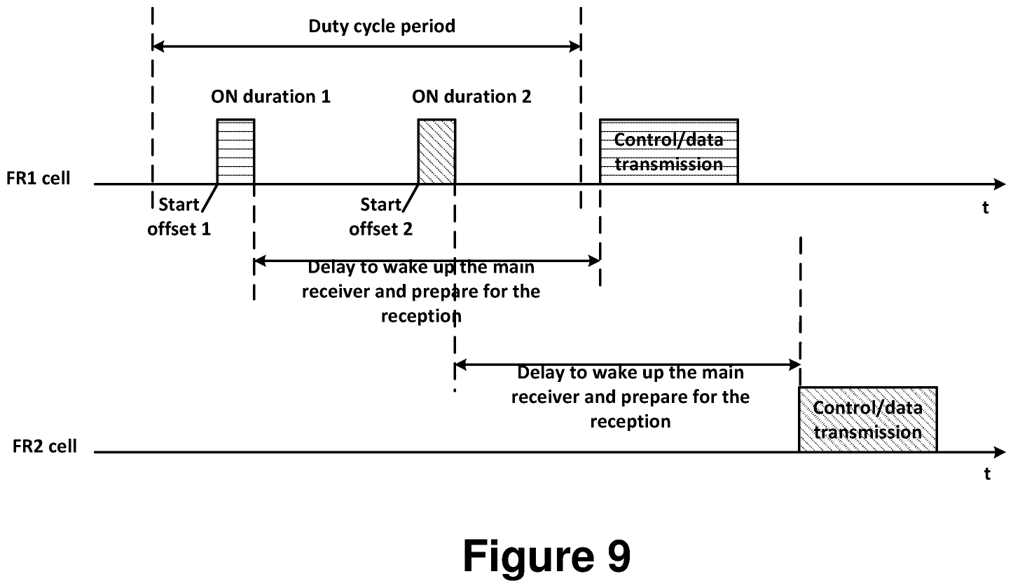

FIG. 9 illustrates another example for the configuration two duty cycles for LP-WUS detection in CONNECTED state. The main receiver may be configured with multiple serving cells for carrier aggregation (CA) operation. The serving cells may include a cell in frequency range 1 (FR1) and a cell in frequency range 2 (FR2). Due to the large difference of the channel condition of different frequency ranges (FRs), NR supports different DRX configurations for the different FR. Under the same logic, the configurations of duty cycle based LP-WUS detection for the two FR can be different. The LP-WUS of the two duty cycle based configuration can be configured on a FR1 cell since a frequency in FRI is more power efficient. In FIG. 9, for simplicity, it is assumed that the two configuration has the same duty cycle period. However, different start offsets e.g. start offset 1 and start offset 2 may be configured for the two configurations respectively considering the transmission on the cells of the two FR.

As used herein, the term Frequency Range 1 (which may be abbreviated as “FR-1, “FR1,” etc.) and/or Frequency Range 2 (which may be abbreviated as “FR-2,” “FR2,” etc,) may refer to frequency bandwidths as defined by the third generation partnership project (3GPP), for example in technical specification (TS) 38.104, whether as previously defined, as defined at the time of filing of the present document, or as may be defined at some future time. In some specific embodiments, Frequency Range 1 may refer to frequency bandwidths between approximately 410 Megahertz (MHz) and approximately 7125 MHz. In other specific embodiments, Frequency Range 1 may refer to frequency bandwidths that are less than or equal to approximately 6000 MHz. Similarly, in specific embodiments, Frequency Range 2 may refer to bandwidths between approximately 24250 MHz and approximately 71000 MHz. In some embodiments, bandwidths between approximately 24250 MHz and approximately 52600 MHz may be referred to as Frequency Range 2-1 (which may be abbreviated as “FR2-1,” “FR 2-1,” etc.). Bandwidths between approximately 52600 MHz and approximately 71000 MHz may be referred to as Frequency Range 2-2 (which may be abbreviated as “FR2-2,” “FR 2-2,” etc.).

In another embodiment, a UE can switch between two or more duty cycle configurations configured for the UE for LP-WUS detection. Each duty cycle configuration may be configured with separate wus-Cycle, wus-StartOffset and wus-OnDuration. The active duty cycle configuration of LP-WUS can be explicitly indicated to the UE or implicitly determined by other configurations. For example, if multiple search space set groups (SSSGs) are configured for a UE, different duty cycle configuration may be applied if a different SSSG becomes active.

In another embodiment, separate duty cycle configurations of LP-WUS for a UE can be configured differently for LP-WUS in DRX OFF or in DRX ON duration. Each duty cycle configuration may be configured with separate wus-Cycle, wus-StartOffset and wus-OnDuration. In one example, wus-Cycle for the duty cycle configuration in DRX ON duration can be shorter than the duty cycle configuration in DRX OFF. Specifically, LP-WUS may be configured consecutively or in all slots or subframes.

In another embodiment, if the DRX operation is configured for the main receiver, for either IDLE/INACTIVE state or CONNECTED state, the duty cycle of the LP-WUS and the periodicity for the DRX operation are related. In one option, UE may expect the duty cycle of the LP-WUS is equal to the periodicity of the DRX operation of main receiver. In another option, the duty cycle of the LP-WUS may be same as or different from the periodicity of the DRX operation of main receiver.

In another embodiment, for a UE configured with LP-WUS based indication, a second set of paging occasion (PO) and if supported, the paging early indication (PEI) PDCCH, e.g., DCI format 2-7 that is associated with the PO, can be configured to the UE. The second set of PO/PEI may be configured with a shorter periodicity than the first set of PO/PEI which is known to all UEs with or without LP-WUR. The second set of PO/PEI can be configured by SIB or UE specific signaling. After a UE detect a LP-WUS, UE may be able to decode PDCCH/PDSCH in a PO/PEI for the UE, if the gap between the PO/PEI and LP-WUS is no smaller than a period X. X can predefined, preconfigured, configured by high layer signaling or reported by UE as UE capability, e.g., the period X is the transition time for the UE to wake up the main radio.

In one option, the duty cycle configuration can be configured for a UE for LP-WUS detection which is separately from the configuration of PO/PEI. The configuration may include wus-Cycle, wus-StartOffset and wus-OnDuration. The timing for a UE to detect LP-WUS is determined according to the duty cycle configuration.

In another option, the timing for a UE to detect LP-WUS is determined according to the configuration of PO/PEI. In one example, the timing for LP-WUS detection is a period X before a PO/PEI in the second set. Alternatively, the timing for LP-WUS detection is a period X before a PO/PEI in either the first or the second set.

In another option, the potential time resource for LP-WUS is configured by a duty cycle configuration, which is separately from the configuration of PO/PEI. The configuration may include wus-Cycle, wus-StartOffset and wus-OnDuration. The timing for a UE to detect LP-WUS is determined according to the duty cycle configuration and the configuration of PO/PEI. For example, a group of LP-WUSs based on the duty cycle configuration is only monitored if it is the most recent group of LP-WUS that is a period X before a PO/PEI in the second set. Alternatively, a group of LP-WUSs based on the duty cycle configuration is only monitored if it is the most recent group of LP-WUS that is a period X before a PO/PEI in either the first or the second set. A group of LP-WUS may include one or multiple resources for LP-WUS detection. A group of LP-WUS may include the LP-WUS in the ON duration in a duty cycle period.

In one option, after the UE detect a LP-WUS, the UE only monitors a PO/PEI in the second set which is at least a period X after the detected LP-WUS.

In another option, after the UE detect a LP-WUS, the UE monitors a PO/PEI in the first or second set whichever is earlier. The monitored PO/PEI in the first or second set must be at least a period X after the detected LP-WUS.

In another embodiment, for a UE configured with LP-WUS based indication, after the UE detect a LP-WUS, the UE monitors a PO/PEI which is derived by LP-WUS. For example, the time and/or frequency resource for a PDCCH for paging or paging early identification is indicated by LP-WUS.

### LP-WUS Determined by DRX of Other Channel/Signals

For the DRX operation in IDLE/INACTIVE state of a UE in Rel-17, the LP-WUS for the UE could be configured in a time position which can be determined referring to the DRX configuration of the UE.

In one embodiment, for a main receiver in IDLE/INACTIVE state, the time location for the detection of LP-WUS of a UE can be determined referring to the first paging frame (PF) of the UE.

In one option, the time location of the LP-WUS for the UE can be determined by a reference point and an offset from the reference point to the start of first LP-WUS of the UE.
The reference point can be the start of a reference frame determined by a frame-level offset from the start of the first PF of the PF(s) associated with the LP-WUS.
The offset is an offset from the reference point to the start of the first LP-WUS for the UE. The offset can be in unit of subframe, slot or OFDM symbol.

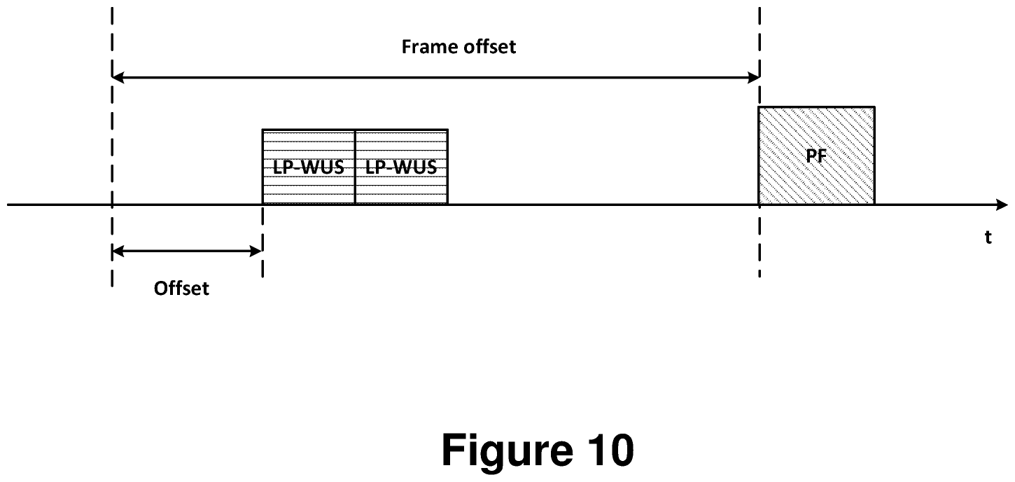

FIG. 10 illustrates one example for determination of time position of LP-WUS. Note: UE may monitor one or multiple LP-WUS in the determined time location.

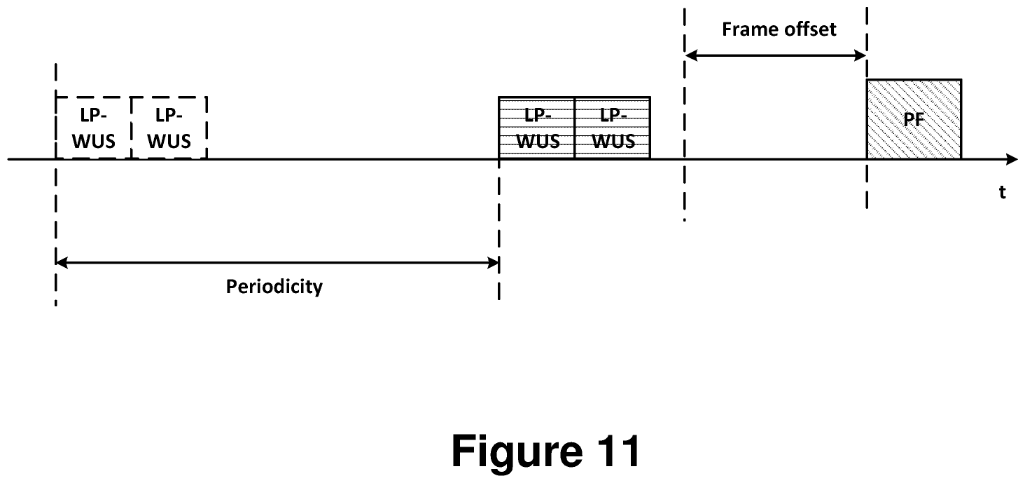

In another option, the possible location of LP-WUS may be configured periodically for a UE, and which location is used for LP-WUS detection is determined according to the first PF of the UE. the monitored LP-WUS(s) of a UE can be the last LP-WUS(s) that are at least X frames, subframes, slots or OFDM symbols earlier than the start of the first PF of the UE. X can be predefined, configured by high layer signalling or reported as UE capability. FIG. 11 illustrates one example for determination of latest time locations of LP-WUS.

In one embodiment, to indicate whether a UE needs to start PDCCH monitoring before the start of next DRX ON duration, the time location for the detection of LP-WUS of the UE can be determined with respect to the start of next DRX ON duration. Such LP-WUS can provide some or all functionalities of DCI format 2_6.

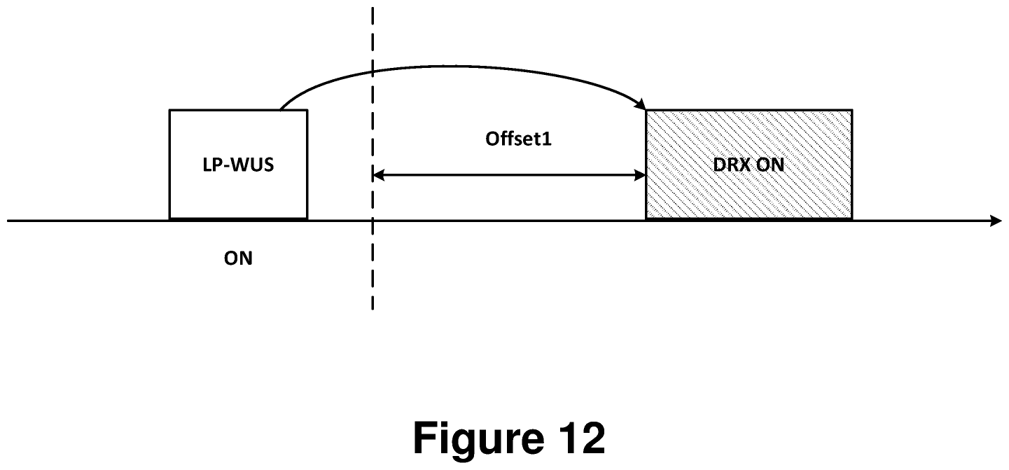

In one option, the timing for LP-WUS detection is at least offset1 before the start of next DRX ON duration. FIG. 12 illustrates one example for determination of the time locations of LP-WUS for the next DRX ON duration. Here, in one example, offset 1 implies minimum time gap between the last monitoring occasion of LP WUS and start of next DRX ON. In other words, UE is not required to monitor LP-WUS during offset1 even if there is an occasion falls within this duration.

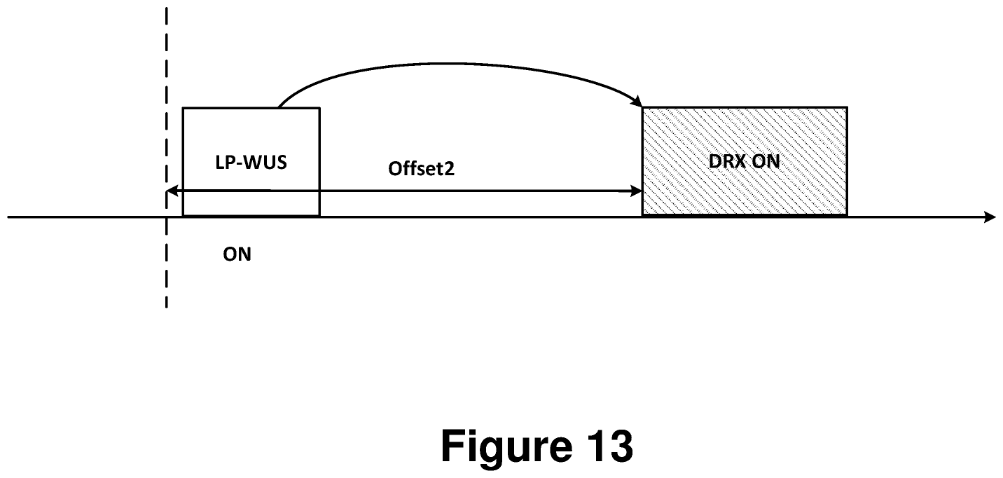

In another option, LP-WUS monitoring and detection starts after a timing that is offset2 before the start of next DRX ON duration. FIG. 13 illustrates one example that the time locations of LP-WUS for the next DRX ON duration. Note: offset2 may only determine the start of a slot, subframe or radio frame. The exact start of the LP-WUS may be latter depending on the structure of the LP-WUS. After the timing location identified from offset2, UE may monitor LP-WUS based on SS Set configuration. In one example, last valid LP-WUS monitoring occasion can be before offset1 shown in FIG. 13, e.g., valid monitoring occasions for LP-WUS reside between time locations indicated by offset2 and offset1. In one example, valid monitoring occasions for LP-WUS are located in the first full duration after offset2 of the configured SS set. In other words, if there are multiple periodic occasions of the SS set where in each periodic occasion, monitoring occasions may span a duration of one or more slots, only the monitoring occasions within the first duration are used by the UE for monitoring LP-WUS.

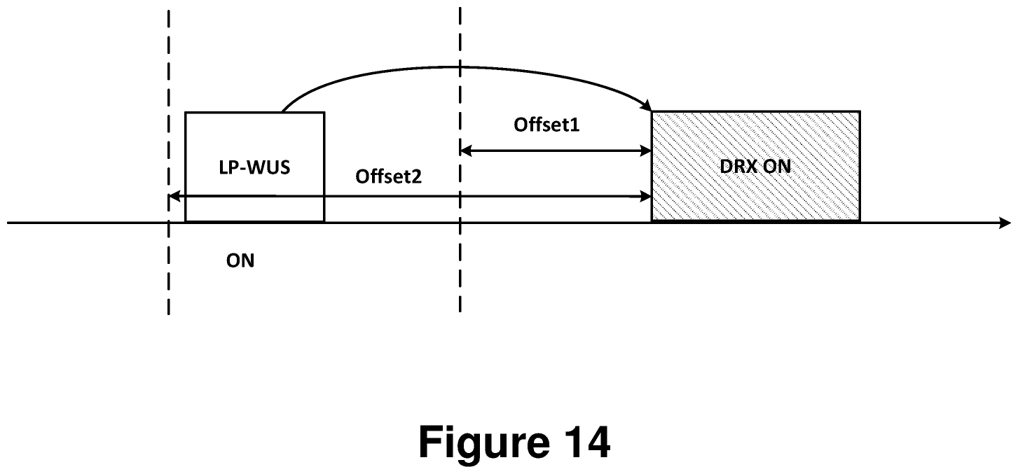

In another option, LP-WUS detection starts after a timing that is offset2 before the start of next DRX ON duration and starts at a timing that is at least offset1 before the start of next DRX ON duration. FIG. 14 illustrates an example related to the window of time locations of LP-WUS for the next DRX ON duration. In this example, UE would expect there is at least one LP-WUS monitoring occasion between the time locations indicated by offset 2 and offset1.

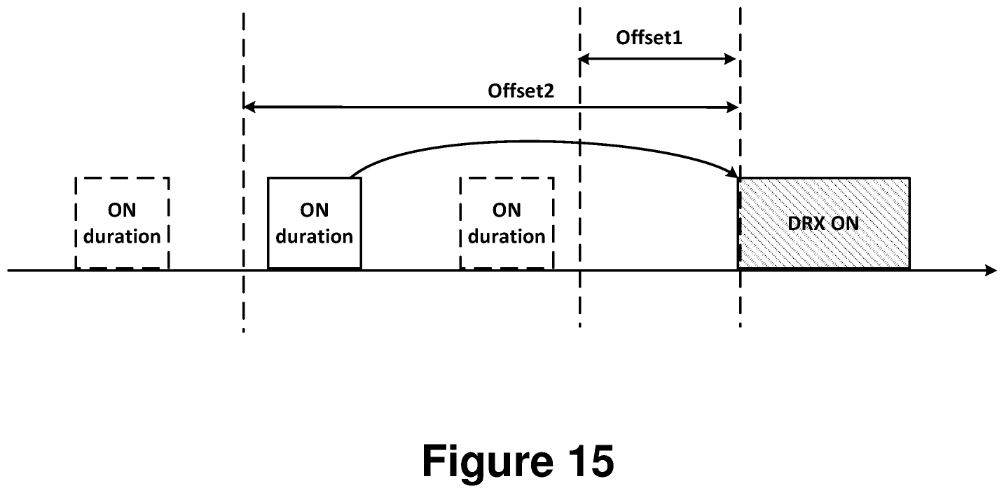

In another option, if the duty cycle configuration is configured for a UE for LP-WUS detection, the UE can monitor LP-WUS in the first full ON duration for LP-WUS. The ON duration starts after a timing that is offset2 before the start of next DRX ON duration and starts at a timing that is at least offset1 before the start of next DRX ON duration. FIG. 15 illustrates an example of the window of time locations of LP-WUS for the next DRX ON duration. The duty cycle configuration may include wus-Cycle, wus-StartOffset and wus-OnDuration. The timing for a UE to detect LP-WUS is determined according to the duty cycle configuration. As extension of FIG. 15, only one or both from the two parameters offset1 and offset2 may be applicable.

### LP-WUS Transmission

Various embodiments in this section relate to techniques for the wake-up signal/channel transmission. For example, embodiments relate to systems and methods to the change the states of the main receiver and the LP-WUR.

The separate low-power wake-up receiver (LP-WUR) has the advantage of extreme low power consumption. If a low-power wake-up signal (LP-WUS) is detected by the LP-WUR, the UE can turn on the main receiver for control/data transmission. Otherwise, the UE may not turn on the main receiver for power saving. Further, it is still beneficial to have two states for the LP-WUR, which are denoted as WUR-ON state and WUR-OFF state. In the WUR-ON state, the LP-WUR can detect LP-WUS, while in the WUR-OFF state, the LP-WUR will not detect any LP-WUS which allows further power saving. One example for the application of two states of LP-WUR is duty cycle based LP-WUS detection. The LP-WUR only detect LP-WUS in the ON duration in a duty cycle period which corresponds to WUR-ON state. In other time of a duty cycle, LP-WUR will not detect LP-WUS, e.g., WUR-OFF state. Further, there may be other conditions to switch between the two states of LP-WUR, as well as the states (IDLE, INACTIVE, CONNECTED) for the main receiver.

In one embodiment, the LP-WUS based wake-up indication may be applicable to all three RRC states (IDLE, INACTIVE, CONNECTED) of main receiver. For the IDLE/INACTIVE state, the LP-WUS may indicate the UE to wake up the main receiver to receive paging message and/or other broadcast information. For CONNECTED state, the LP-WUS may indicate the UE should be active in the next DRX ON period, or the LP-WUS may indicate the UE should be active after a delay.

In one example, the pattern for UE to monitor LP-WUS may be different for the different states of main receiver. In another example, the information carried by LP-WUS may be different for the different states of main receiver.

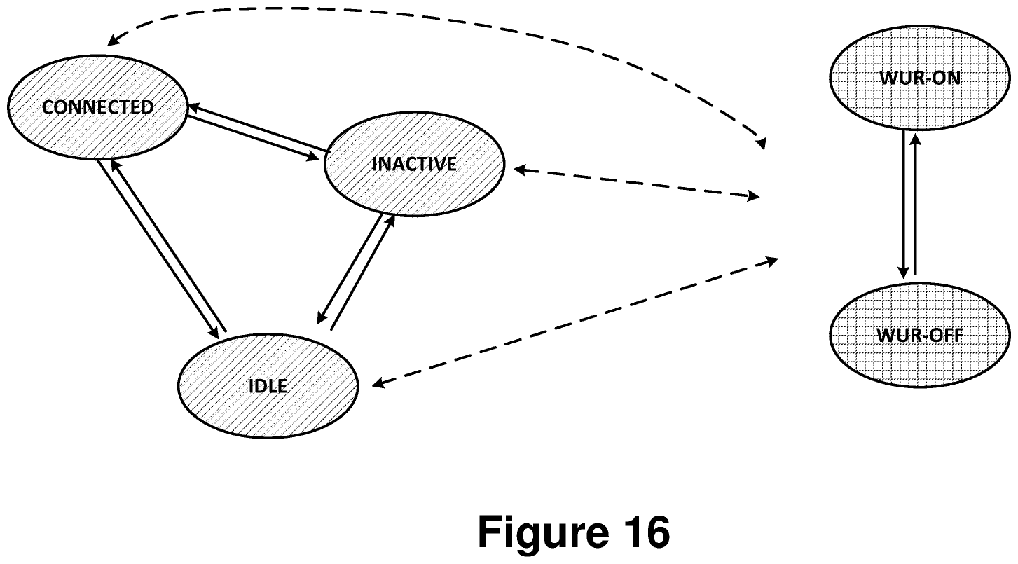

FIG. 16 illustrates one general example for the states of the main receiver and the WUR. The main receiver may switch among three states, IDLE, INACTIVE, CONNECTED, while the WUR can switch between two states, e.g., WUR-ON, WUR-OFF.

In one option, the two states of LP-WUR are applicable for any of the three states of the main receiver. The possible combination of states of the main receiver and WUR are: IDLE-WUR-ON, IDLE-WUR-OFF, INACTIVE-WUR-ON, INACTIVE-WUR-OFF, CONNECTED-WUR-ON, CONNECTED-WUR-OFF.

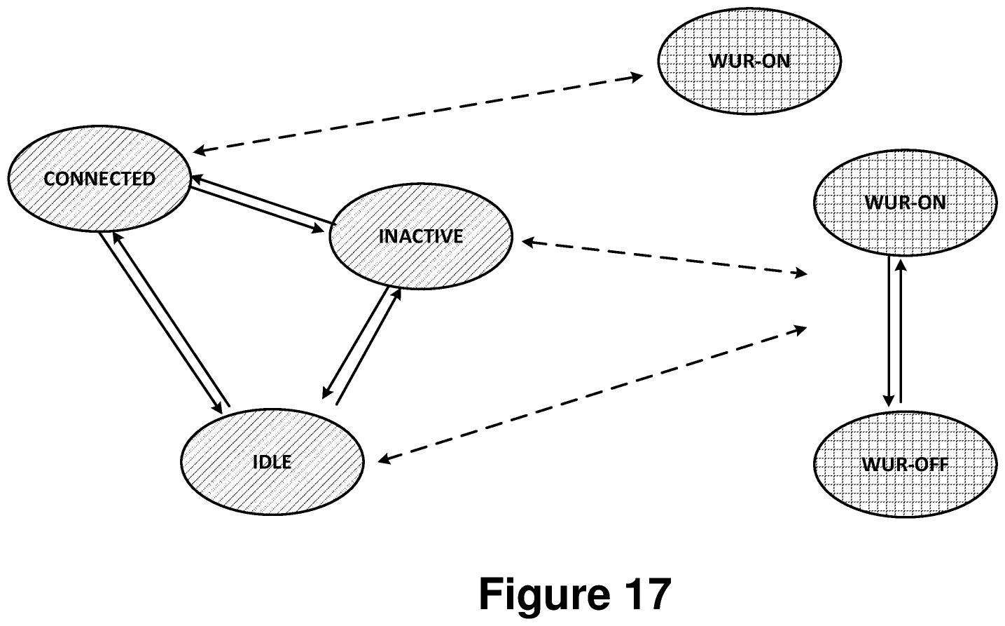

In one option, LP-WUR can be in either WUR-ON or WUR-OFF state when the main receiver is in IDLE/INACTIVE state. However, if the main receiver is in CONNECTED state, the LP-WUR should be always active, e.g., stay at WUR-ON state. The possible combination of states of the main receiver and WUR are: IDLE-WUR-ON, IDLE-WUR-OFF, INACTIVE-WUR-ON, INACTIVE-WUR-OFF, CONNECTED-WUR-ON. FIG. 17 illustrates one example for the possible states of the main receiver and the WUR.

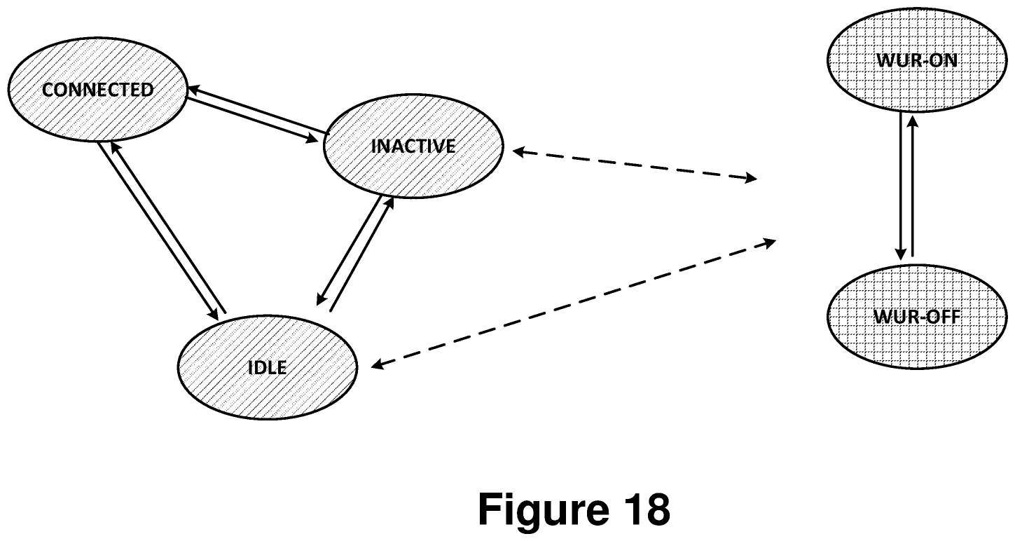

In one embodiment, the LP-WUS based wake-up indication may be only applicable to IDLE/INACTIVE states of main receiver. The LP-WUR can be turned off when the main receiver is in CONNECTED state. The possible combination of states of the main receiver and WUR are: IDLE-WUR-ON, IDLE-WUR-OFF, INACTIVE-WUR-ON, INACTIVE-WUR-OFF, CONNECTED-N/A. In one example, the pattern for UE to monitor LP-WUS may be different for the IDLE or INACTIVE states of main receiver. In another example, the information carried by LP-WUS may be different for the IDLE or INACTIVE states of main receiver. FIG. 18 illustrates one example for the states of the main receiver and the WUR.

In one embodiment, gNB may provide multiple configurations of LP-WUS. UE may select one configuration of LP-WUS for LP-WUR according to RRC states of the main receiver. For example, gNB provides two configurations of LP-WUS, one is with larger duty cycle and the other is with smaller duty cycle. When the main receiver is in RRC idle state, the configuration with larger duty cycle is applied for LP-WUR, while the configuration with shorter duty cycle is applied for LP-WUR is the main receiver is in RRC connected mode, to reduce the latency.

The switching of the RRC states of the main receiver can be independent or dependent from the state of LP-WUR.

In one embodiment, UE determines when the main receiver goes to sleep according to pre-defined rules. In one option, when UE enters certain RRC state, e.g., RRC idle state and/or RRC inactive state, the main receiver can go to sleep. In another option, when a timer which starts upon the UE enters certain RRC state (e.g., RRC idle and/or RRC inactive state) expires, the main receiver goes to sleep.

The sleep mode for the main receiver includes at least one of off state, deep sleep state or light sleep state.

For different RRC state, the sleep mode for the main receiver can be different, e.g., the sleep mode of main receiver is off state for RRC idle state, while the sleep mode of main receiver is deep sleep state for RRC connected state.

### Systems and Implementations

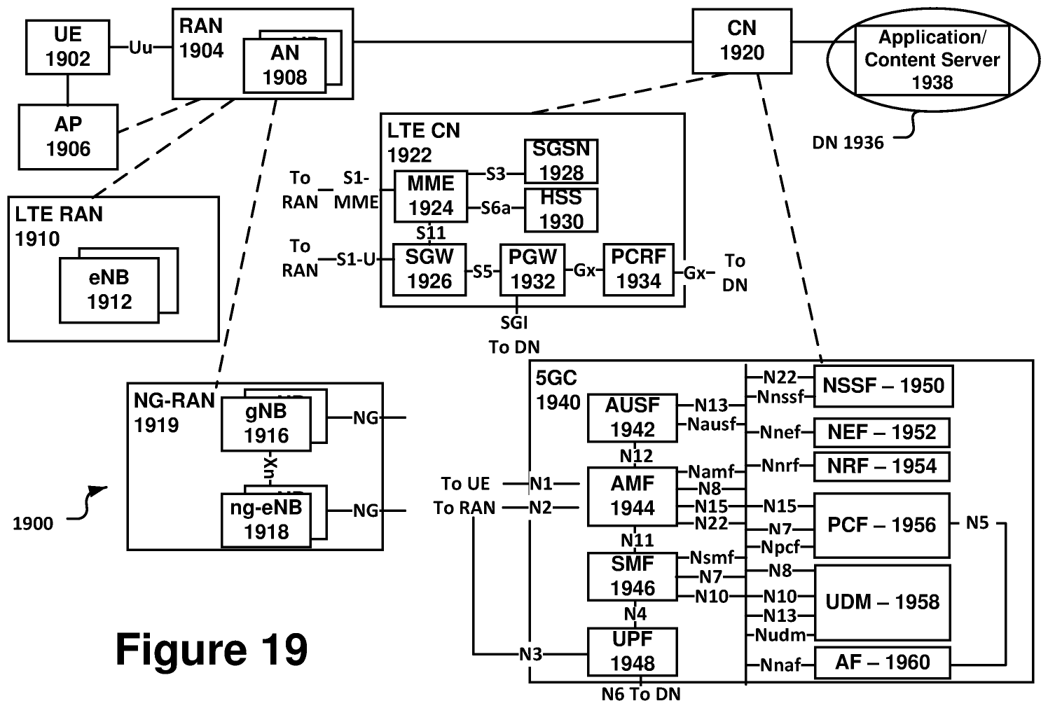

FIGS. 19-22 illustrate various systems, devices, and components that may implement aspects of disclosed embodiments.

FIG. 19 illustrates a network 1900 in accordance with various embodiments. The network 1900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1900 may include a UE 1902, which may include any mobile or non-mobile computing device designed to communicate with a RAN 1904 via an over-the-air connection. The UE 1902 may be communicatively coupled with the RAN 1904 by a Uu interface. The UE 1902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1902 may additionally communicate with an AP 1906 via an over-the-air connection. The AP 1906 may manage a WLAN connection, which may serve to offload some/all network traffic from the RAN 1904. The connection between the UE 1902 and the AP 1906 may be consistent with any IEEE 802.11 protocol, wherein the AP 1906 could be a wireless fidelity (Wi-Fi®) router. In some embodiments, the UE 1902, RAN 1904, and AP 1906 may utilize cellular-WLAN aggregation (for example, LWA/LWIP). Cellular-WLAN aggregation may involve the UE 1902 being configured by the RAN 1904 to utilize both cellular radio resources and WLAN resources.

The RAN 1904 may include one or more access nodes, for example, AN 1908. AN 1908 may terminate air-interface protocols for the UE 1902 by providing access stratum protocols including RRC, PDCP, RLC, MAC, and L1 protocols. In this manner, the AN 1908 may enable data/voice connectivity between CN 1920 and the UE 1902. In some embodiments, the AN 1908 may be implemented in a discrete device or as one or more software entities running on server computers as part of, for example, a virtual network, which may be referred to as a CRAN or virtual baseband unit pool. The AN 1908 be referred to as a BS, gNB, RAN node, eNB, ng-eNB, NodeB, RSU, TRxP, TRP, etc. The AN 1908 may be a macrocell base station or a low power base station for providing femtocells, picocells or other like cells having smaller coverage areas, smaller user capacity, or higher bandwidth compared to macrocells.

In embodiments in which the RAN 1904 includes a plurality of ANs, they may be coupled with one another via an X2 interface (if the RAN 1904 is an LTE RAN) or an Xn interface (if the RAN 1904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1904 may each manage one or more cells, cell groups, component carriers, etc. to provide the UE 1902 with an air interface for network access. The UE 1902 may be simultaneously connected with a plurality of cells provided by the same or different ANs of the RAN 1904. For example, the UE 1902 and RAN 1904 may use carrier aggregation to allow the UE 1902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1902 or AN 1908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1904 may be an LTE RAN 1910 with eNBs, for example, eNB 1912. The LTE RAN 1910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1904 may be an NG-RAN 1914 with gNBs, for example, gNB 1916, or ng-eNBs, for example, ng-eNB 1918. The gNB 1916 may connect with 5G-enabled UEs using a 5G NR interface. The gNB 1916 may connect with a 5G core through an NG interface, which may include an N2 interface or an N3 interface. The ng-eNB 1918 may also connect with the 5G core through an NG interface, but may connect with a UE via an LTE air interface. The gNB 1916 and the ng-eNB 1918 may connect with each other over an Xn interface.

In some embodiments, the NG interface may be split into two parts, an NG user plane (NG-U) interface, which carries traffic data between the nodes of the NG-RAN 1914 and a UPF 1948 (e.g., N3 interface), and an NG control plane (NG-C) interface, which is a signaling interface between the nodes of the NG-RAN 1914 and an AMF 1944 (e.g., N2 interface).

The NG-RAN 1914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1902 can be configured with multiple BWPs where each BWP configuration has a different SCS. When a BWP change is indicated to the UE 1902, the SCS of the transmission is changed as well. Another use case example of BWP is related to power saving. In particular, multiple BWPs can be configured for the UE 1902 with different amount of frequency resources (for example, PRBs) to support data transmission under different traffic loading scenarios. A BWP containing a smaller number of PRBs can be used for data transmission with small traffic load while allowing power saving at the UE 1902 and in some cases at the gNB 1916. A BWP containing a larger number of PRBs can be used for scenarios with higher traffic load.

The RAN 1904 is communicatively coupled to CN 1920 that includes network elements to provide various functions to support data and telecommunications services to customers/subscribers (for example, users of UE 1902). The components of the CN 1920 may be implemented in one physical node or separate physical nodes. In some embodiments, NFV may be utilized to virtualize any or all of the functions provided by the network elements of the CN 1920 onto physical compute/storage resources in servers, switches, etc. A logical instantiation of the CN 1920 may be referred to as a network slice, and a logical instantiation of a portion of the CN 1920 may be referred to as a network sub-slice.

In some embodiments, the CN 1920 may be an LTE CN 1922, which may also be referred to as an EPC. The LTE CN 1922 may include MME 1924, SGW 1926, SGSN 1928, HSS 1930, PGW 1932, and PCRF 1934 coupled with one another over interfaces (or “reference points”) as shown. Functions of the elements of the LTE CN 1922 may be briefly introduced as follows.

The MME 1924 may implement mobility management functions to track a current location of the UE 1902 to facilitate paging, bearer activation/deactivation, handovers, gateway selection, authentication, etc.

The SGW 1926 may terminate an SI interface toward the RAN and route data packets between the RAN and the LTE CN 1922. The SGW 1926 may be a local mobility anchor point for inter-RAN node handovers and also may provide an anchor for inter-3GPP mobility. Other responsibilities may include lawful intercept, charging, and some policy enforcement.

The SGSN 1928 may track a location of the UE 1902 and perform security functions and access control. In addition, the SGSN 1928 may perform inter-EPC node signaling for mobility between different RAT networks; PDN and S-GW selection as specified by MME 1924; MME selection for handovers; etc. The S3 reference point between the MME 1924 and the SGSN 1928 may enable user and bearer information exchange for inter-3GPP access network mobility in idle/active states.

The HSS 1930 may include a database for network users, including subscription-related information to support the network entities' handling of communication sessions. The HSS 1930 can provide support for routing/roaming, authentication, authorization, naming/addressing resolution, location dependencies, etc. An S6a reference point between the HSS 1930 and the MME 1924 may enable transfer of subscription and authentication data for authenticating/authorizing user access to the LTE CN 1920.

The PGW 1932 may terminate an SGi interface toward a data network (DN) 1936 that may include an application/content server 1938. The PGW 1932 may route data packets between the LTE CN 1922 and the data network 1936. The PGW 1932 may be coupled with the SGW 1926 by an S5 reference point to facilitate user plane tunneling and tunnel management. The PGW 1932 may further include a node for policy enforcement and charging data collection (for example, PCEF). Additionally, the SGi reference point between the PGW 1932 and the data network 1936 may be an operator external public, a private PDN, or an intra-operator packet data network, for example, for provision of IMS services. The PGW 1932 may be coupled with a PCRF 1934 via a Gx reference point.

The PCRF 1934 is the policy and charging control element of the LTE CN 1922. The PCRF 1934 may be communicatively coupled to the app/content server 1938 to determine appropriate QoS and charging parameters for service flows. The PCRF 1932 may provision associated rules into a PCEF (via Gx reference point) with appropriate TFT and QCI.

In some embodiments, the CN 1920 may be a 5GC 1940. The 5GC 1940 may include an AUSF 1942, AMF 1944, SMF 1946, UPF 1948, NSSF 1950, NEF 1952, NRF 1954, PCF 1956, UDM 1958, and AF 1960 coupled with one another over interfaces (or “reference points”) as shown. Functions of the elements of the 5GC 1940 may be briefly introduced as follows.

The AUSF 1942 may store data for authentication of UE 1902 and handle authentication-related functionality. The AUSF 1942 may facilitate a common authentication framework for various access types. In addition to communicating with other elements of the 5GC 1940 over reference points as shown, the AUSF 1942 may exhibit an Nausf service-based interface.

The AMF 1944 may allow other functions of the 5GC 1940 to communicate with the UE 1902 and the RAN 1904 and to subscribe to notifications about mobility events with respect to the UE 1902. The AMF 1944 may be responsible for registration management (for example, for registering UE 1902), connection management, reachability management, mobility management, lawful interception of AMF-related events, and access authentication and authorization. The AMF 1944 may provide transport for SM messages between the UE 1902 and the SMF 1946, and act as a transparent proxy for routing SM messages. AMF 1944 may also provide transport for SMS messages between UE 1902 and an SMSF. AMF 1944 may interact with the AUSF 1942 and the UE 1902 to perform various security anchor and context management functions. Furthermore, A M F 1944 may be a termination point of a RAN CP interface, which may include or be an N2 reference point between the RAN 1904 and the AMF 1944; and the AMF 1944 may be a termination point of NAS (N1) signaling, and perform NAS ciphering and integrity protection. AMF 1944 may also support NAS signaling with the UE 1902 over an N3 IWF interface.

The SMF 1946 may be responsible for SM (for example, session establishment, tunnel management between UPF 1948 and AN 1908); UE IP address allocation and management (including optional authorization); selection and control of UP function; configuring traffic steering at UPF 1948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1944 over N2 to AN 1908; and determining SSC mode of a session. SM may refer to management of a PDU session, and a PDU session or “session” may refer to a PDU connectivity service that provides or enables the exchange of PDUs between the UE 1902 and the data network 1936.

The UPF 1948 may act as an anchor point for intra-RAT and inter-RAT mobility, an external PDU session point of interconnect to data network 1936, and a branching point to support multi-homed PDU session. The UPF 1948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1948 may include an uplink classifier to support routing traffic flows to a data network.

The NSSF 1950 may select a set of network slice instances serving the UE 1902. The NSSF 1950 may also determine allowed NSSAI and the mapping to the subscribed S-NSSAIs, if needed. The NSSF 1950 may also determine the AMF set to be used to serve the UE 1902, or a list of candidate AMFs based on a suitable configuration and possibly by querying the NRF 1954. The selection of a set of network slice instances for the UE 1902 may be triggered by the AMF 1944 with which the UE 1902 is registered by interacting with the NSSF 1950, which may lead to a change of AMF. The NSSF 1950 may interact with the AMF 1944 via an N22 reference point; and may communicate with another NSSF in a visited network via an N31 reference point (not shown). Additionally, the NSSF 1950 may exhibit an Nnssf service-based interface.

The NEF 1952 may securely expose services and capabilities provided by 3GPP network functions for third party, internal exposure/re-exposure, AFs (e.g., AF 1960), edge computing or fog computing systems, etc. In such embodiments, the NEF 1952 may authenticate, authorize, or throttle the AFs. NEF 1952 may also translate information exchanged with the AF 1960 and information exchanged with internal network functions. For example, the NEF 1952 may translate between an AF-Service-Identifier and an internal 5GC information. NEF 1952 may also receive information from other NFs based on exposed capabilities of other NFs. This information may be stored at the NEF 1952 as structured data, or at a data storage NF using standardized interfaces. The stored information can then be re-exposed by the NEF 1952 to other NFs and AFs, or used for other purposes such as analytics. Additionally, the NEF 1952 may exhibit an Nnef service-based interface.

The NRF 1954 may support service discovery functions, receive NF discovery requests from NF instances, and provide the information of the discovered NF instances to the NF instances. NRF 1954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1954 may exhibit the Nnrf service-based interface.

The PCF 1956 may provide policy rules to control plane functions to enforce them, and may also support unified policy framework to govern network behavior. The PCF 1956 may also implement a front end to access subscription information relevant for policy decisions in a UDR of the UDM 1958. In addition to communicating with functions over reference points as shown, the PCF 1956 exhibit an Npcf service-based interface.

The UDM 1958 may handle subscription-related information to support the network entities' handling of communication sessions, and may store subscription data of UE 1902. For example, subscription data may be communicated via an N8 reference point between the UDM 1958 and the AMF 1944. The UDM 1958 may include two parts, an application front end and a UDR. The UDR may store subscription data and policy data for the UDM 1958 and the PCF 1956, and/or structured data for exposure and application data (including PFDs for application detection, application request information for multiple UEs 1902) for the NEF 1952. The Nudr service-based interface may be exhibited by the UDR 221 to allow the UDM 1958, PCF 1956, and NEF 1952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1958 may exhibit the Nudm service-based interface.

The AF 1960 may provide application influence on traffic routing, provide access to NEF, and interact with the policy framework for policy control.

In some embodiments, the 5GC 1940 may enable edge computing by selecting operator/3^{rd} party services to be geographically close to a point that the UE 1902 is attached to the network. This may reduce latency and load on the network. To provide edge-computing implementations, the 5GC 1940 may select a UPF 1948 close to the UE 1902 and execute traffic steering from the UPF 1948 to data network 1936 via the N6 interface. This may be based on the UE subscription data, UE location, and information provided by the AF 1960. In this way, the AF 1960 may influence UPF (re) selection and traffic routing. Based on operator deployment, when AF 1960 is considered to be a trusted entity, the network operator may permit AF 1960 to interact directly with relevant NFs. Additionally, the AF 1960 may exhibit an Naf service-based interface.

The data network 1936 may represent various network operator services, Internet access, or third party services that may be provided by one or more servers including, for example, application/content server 1938.

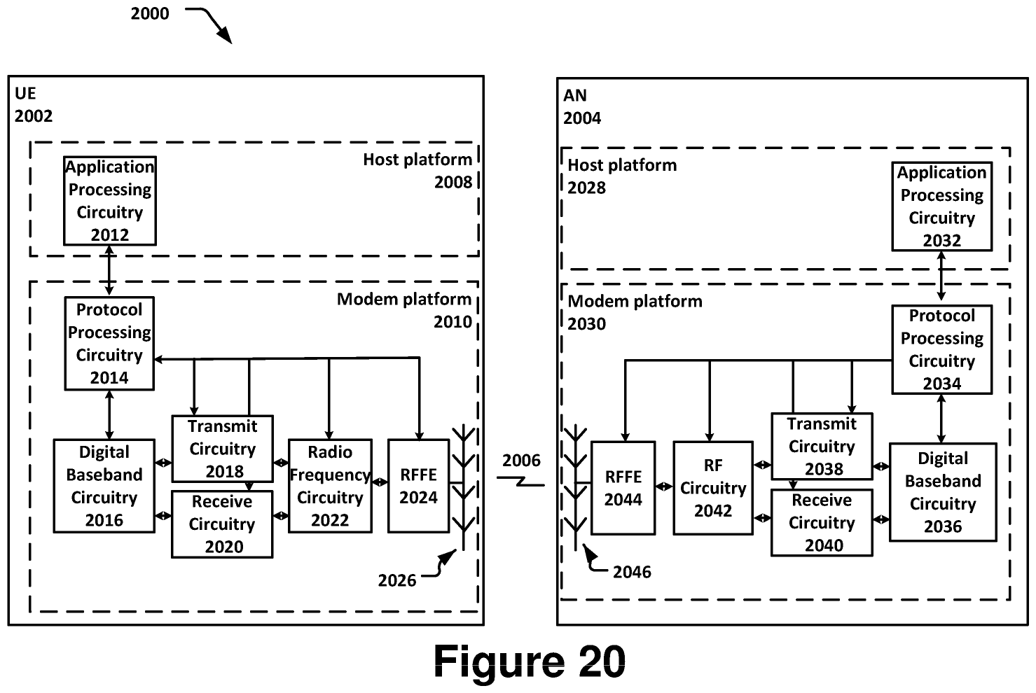

FIG. 20 schematically illustrates a wireless network 2000 in accordance with various embodiments. The wireless network 2000 may include a UE 2002 in wireless communication with an AN 2004. The UE 2002 and AN 2004 may be similar to, and substantially interchangeable with, like-named components described elsewhere herein.

The UE 2002 may be communicatively coupled with the AN 2004 via connection 2006. The connection 2006 is illustrated as an air interface to enable communicative coupling, and can be consistent with cellular communications protocols such as an LTE protocol or a 5G NR protocol operating at mm Wave or sub-6 GHZ frequencies.

The UE 2002 may include a host platform 2008 coupled with a modem platform 2010. The host platform 2008 may include application processing circuitry 2012, which may be coupled with protocol processing circuitry 2014 of the modem platform 2010. The application processing circuitry 2012 may run various applications for the UE 2002 that source/sink application data. The application processing circuitry 2012 may further implement one or more layer operations to transmit/receive application data to/from a data network. These layer operations may include transport (for example UDP) and Internet (for example, IP) operations

The protocol processing circuitry 2014 may implement one or more of layer operations to facilitate transmission or reception of data over the connection 2006. The layer operations implemented by the protocol processing circuitry 2014 may include, for example, MAC, RLC, PDCP, RRC and NAS operations.

The modem platform 2010 may further include digital baseband circuitry 2016 that may implement one or more layer operations that are “below” layer operations performed by the protocol processing circuitry 2014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 2010 may further include transmit circuitry 2018, receive circuitry 2020, RF circuitry 2022, and RF front end (RFFE) 2024, which may include or connect to one or more antenna panels 2026. Briefly, the transmit circuitry 2018 may include a digital-to-analog converter, mixer, intermediate frequency (IF) components, etc.; the receive circuitry 2020 may include an analog-to-digital converter, mixer, IF components, etc.; the RF circuitry 2022 may include a low-noise amplifier, a power amplifier, power tracking components, etc.; RFFE 2024 may include filters (for example, surface/bulk acoustic wave filters), switches, antenna tuners, beamforming components (for example, phase-array antenna components), etc. The selection and arrangement of the components of the transmit circuitry 2018, receive circuitry 2020, RF circuitry 2022, RFFE 2024, and antenna panels 2026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 2014 may include one or more instances of control circuitry (not shown) to provide control functions for the transmit/receive components.

A UE reception may be established by and via the antenna panels 2026, RFFE 2024, RF circuitry 2022, receive circuitry 2020, digital baseband circuitry 2016, and protocol processing circuitry 2014. In some embodiments, the antenna panels 2026 may receive a transmission from the AN 2004 by receive-beamforming signals received by a plurality of antennas/antenna elements of the one or more antenna panels 2026.

A UE transmission may be established by and via the protocol processing circuitry 2014, digital baseband circuitry 2016, transmit circuitry 2018, RF circuitry 2022, RFFE 2024, and antenna panels 2026. In some embodiments, the transmit components of the UE 2004 may apply a spatial filter to the data to be transmitted to form a transmit beam emitted by the antenna elements of the antenna panels 2026.

Similar to the UE 2002, the AN 2004 may include a host platform 2028 coupled with a modem platform 2030. The host platform 2028 may include application processing circuitry 2032 coupled with protocol processing circuitry 2034 of the modem platform 2030. The modem platform may further include digital baseband circuitry 2036, transmit circuitry 2038, receive circuitry 2040, RF circuitry 2042, RFFE circuitry 2044, and antenna panels 2046. The components of the AN 2004 may be similar to and substantially interchangeable with like-named components of the UE 2002. In addition to performing data transmission/reception as described above, the components of the AN 2008 may perform various logical functions that include, for example, RNC functions such as radio bearer management, uplink and downlink dynamic radio resource management, and data packet scheduling.

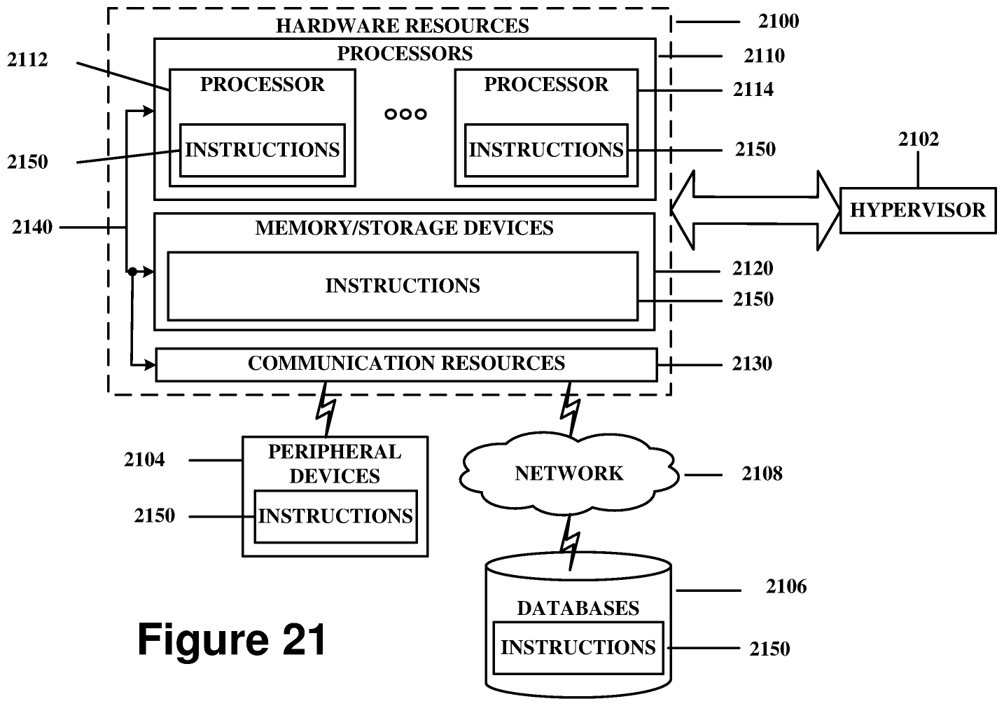

FIG. 21 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 21 shows a diagrammatic representation of hardware resources 2100 including one or more processors (or processor cores) 2110, one or more memory/storage devices 2120, and one or more communication resources 2130, each of which may be communicatively coupled via a bus 2140 or other interface circuitry. For embodiments where node virtualization (e.g., NFV) is utilized, a hypervisor 2102 may be executed to provide an execution environment for one or more network slices/sub-slices to utilize the hardware resources 2100.

The processors 2110 may include, for example, a processor 2112 and a processor 2114. The processors 2110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2120 may include main memory, disk storage, or any suitable combination thereof. The memory/storage devices 2120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2130 may include interconnection or network interface controllers, components, or other suitable devices to communicate with one or more peripheral devices 2104 or one or more databases 2106 or other network elements via a network 2108. For example, the communication resources 2130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2150 may comprise software, a program, an application, an applet, an app, or other executable code for causing at least any of the processors 2110 to perform any one or more of the methodologies discussed herein. The instructions 2150 may reside, completely or partially, within at least one of the processors 2110 (e.g., within the processor's cache memory), the memory/storage devices 2120, or any suitable combination thereof. Furthermore, any portion of the instructions 2150 may be transferred to the hardware resources 2100 from any combination of the peripheral devices 2104 or the databases 2106. Accordingly, the memory of processors 2110, the memory/storage devices 2120, the peripheral devices 2104, and the databases 2106 are examples of computer-readable and machine-readable media.

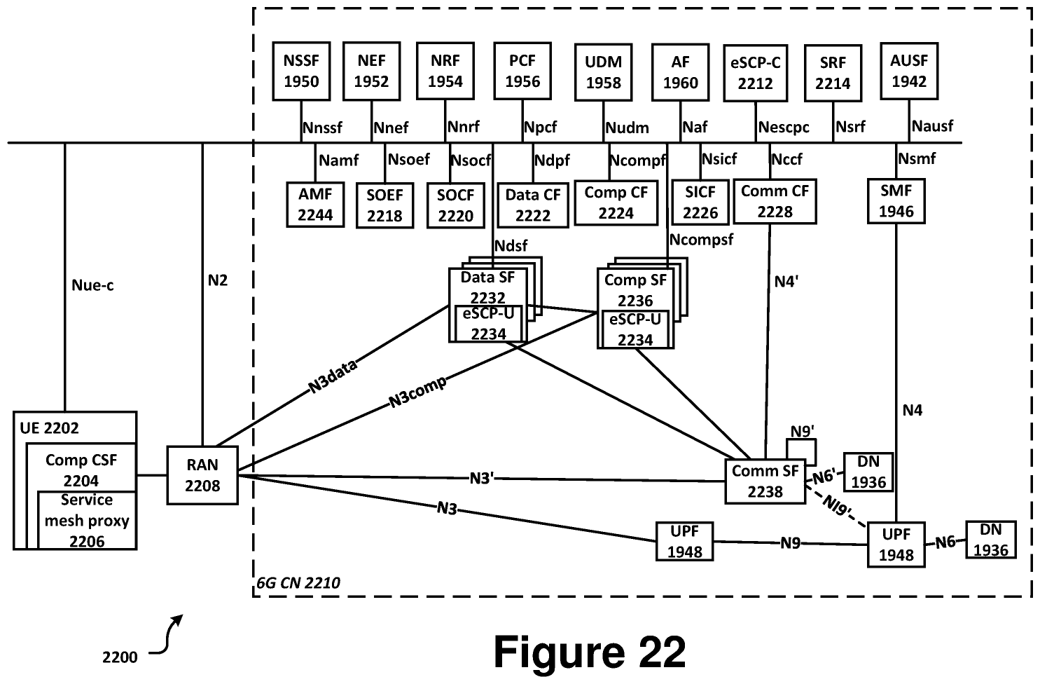

FIG. 22 illustrates a network 2200 in accordance with various embodiments. The network 2200 may operate in a matter consistent with 3GPP technical specifications or technical reports for 6G systems. In some embodiments, the network 2200 may operate concurrently with network 1900. For example, in some embodiments, the network 2200 may share one or more frequency or bandwidth resources with network 1900. As one specific example, a UE (e.g., UE 2202) may be configured to operate in both network 2200 and network 1900. Such configuration may be based on a UE including circuitry configured for communication with frequency and bandwidth resources of both networks 1900 and 2200. In general, several elements of network 2200 may share one or more characteristics with elements of network 1900. For the sake of brevity and clarity, such elements may not be repeated in the description of network 2200.

The network 2200 may include a UE 2202, which may include any mobile or non-mobile computing device designed to communicate with a RAN 2208 via an over-the-air connection. The UE 2202 may be similar to, for example, UE 1902. The UE 2202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 22, in some embodiments the network 2200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 22, the UE 2202 may be communicatively coupled with an AP such as AP 1906 as described with respect to FIG. 19. Additionally, although not specifically shown in FIG. 22, in some embodiments the RAN 2208 may include one or more ANss such as AN 1908 as described with respect to FIG. 19. The RAN 2208 and/or the AN of the RAN 2208 may be referred to as a base station (BS), a RAN node, or using some other term or name.

The UE 2202 and the RAN 2208 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 2208 may allow for communication between the UE 2202 and a 6G core network (CN) 2210. Specifically, the RAN 2208 may facilitate the transmission and reception of data between the UE 2202 and the 6G CN 2210. The 6G CN 2210 may include various functions such as NSSF 1950, NEF 1952, NRF 1954, PCF 1956, UDM 1958, AF 1960, SMF 1946, and AUSF 1942. The 6G CN 2210 may additional include UPF 1948 and DN 1936 as shown in FIG. 22.

Additionally, the RAN 2208 may include various additional functions that are in addition to, or alternative to, functions of a legacy cellular network such as a 4G or 5G network. Two such functions may include a Compute Control Function (Comp CF) 2224 and a Compute Service Function (Comp SF) 2236. The Comp CF 2224 and the Comp SF 2236 may be parts or functions of the Computing Service Plane. Comp CF 2224 may be a control plane function that provides functionalities such as management of the Comp SF 2236, computing task context generation and management (e.g., create, read, modify, delete), interaction with the underlaying computing infrastructure for computing resource management, etc., Comp SF 2236 may be a user plane function that serves as the gateway to interface computing service users (such as UE 2202) and computing nodes behind a Comp SF instance. Some functionalities of the Comp SF 2236 may include: parse computing service data received from users to compute tasks executable by computing nodes; hold service mesh ingress gateway or service API gateway; service and charging policies enforcement; performance monitoring and telemetry collection, etc. In some embodiments, a Comp SF 2236 instance may serve as the user plane gateway for a cluster of computing nodes. A Comp CF 2224 instance may control one or more Comp SF 2236 instances.

Two other such functions may include a Communication Control Function (Comm CF) 2228 and a Communication Service Function (Comm SF) 2238, which may be parts of the Communication Service Plane. The Comm CF 2228 may be the control plane function for managing the Comm SF 2238, communication sessions creation/configuration/releasing, and managing communication session context. The Comm SF 2238 may be a user plane function for data transport. Comm CF 2228 and Comm SF 2238 may be considered as upgrades of SMF 1946 and UPF 1948, which were described with respect to a 5G system in FIG. 19. The upgrades provided by the Comm CF 2228 and the Comm SF 2238 may enable service-aware transport. For legacy (e.g., 4G or 5G) data transport, SMF 1946 and UPF 1948 may still be used.

Two other such functions may include a Data Control Function (Data CF) 2222 and Data Service Function (Data SF) 2232 may be parts of the Data Service Plane. Data CF 2222 may be a control plane function and provides functionalities such as Data SF 2232 management, Data service creation/configuration/releasing, Data service context management, etc. Data SF 2232 may be a user plane function and serve as the gateway between data service users (such as UE 2202 and the various functions of the 6G CN 2210) and data service endpoints behind the gateway. Specific functionalities may include include: parse data service user data and forward to corresponding data service endpoints, generate charging data, report data service status.

Another such function may be the Service Orchestration and Chaining Function (SOCF) 2220, which may discover, orchestrate and chain up communication/computing/data services provided by functions in the network. Upon receiving service requests from users, SOCF 2220 may interact with one or more of Comp CF 2224, Comm CF 2228, and Data CF 2222 to identify Comp SF 2236, Comm SF 2238, and Data SF 2232 instances, configure service resources, and generate the service chain, which could contain multiple Comp SF 2236, Comm SF 2238, and Data SF 2232 instances and their associated computing endpoints. Workload processing and data movement may then be conducted within the generated service chain. The SOCF 2220 may also responsible for maintaining, updating, and releasing a created service chain.

Another such function may be the service registration function (SRF) 2214, which may act as a registry for system services provided in the user plane such as services provided by service endpoints behind Comp SF 2236 and Data SF 2232 gateways and services provided by the UE 2202. The SRF 2214 may be considered a counterpart of NRF 1954, which may act as the registry for network functions.

Other such functions may include an evolved service communication proxy (eSCP) and service infrastructure control function (SICF) 2226, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 2212 and eSCP-U 2234, for control plane service communication proxy and user plane service communication proxy, respectively. The SICF 2226 may control and configure eCSP instances in terms of service traffic routing policies, access rules, load balancing configurations, performance monitoring, etc.

Another such function is the AMF 2244. The AMF 2244 may be similar to 1944, but with additional functionality. Specifically, the AMF 2244 may include potential functional repartition, such as move the message forwarding functionality from the AMF 2244 to the RAN 2208.

Another such function is the service orchestration exposure function (SOEF) 2218. The SOEF may be configured to expose service orchestration and chaining services to external users such as applications.

The UE 2202 may include an additional function that is referred to as a computing client service function (comp CSF) 2204. The comp CSF 2204 may have both the control plane functionalities and user plane functionalities, and may interact with corresponding network side functions such as SOCF 2220, Comp CF 2224, Comp SF 2236, Data CF 2222, and/or Data SF 2232 for service discovery, request/response, compute task workload exchange, etc. The Comp CSF 2204 may also work with network side functions to decide on whether a computing task should be run on the UE 2202, the RAN 2208, and/or an element of the 6G CN 2210.

The UE 2202 and/or the Comp CSF 2204 may include a service mesh proxy 2206. The service mesh proxy 2206 may act as a proxy for service-to-service communication in the user plane. Capabilities of the service mesh proxy 2206 may include one or more of addressing, security, load balancing, etc.

### EXAMPLE PROCEDURES

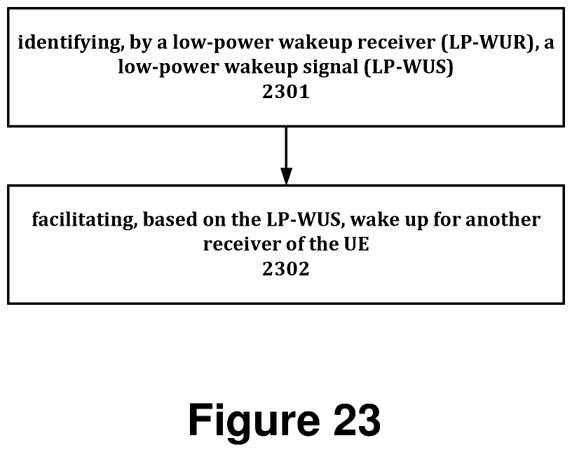

In some embodiments, the electronic device(s), network(s), system(s), chip(s) or component(s), or portions or implementations thereof, of FIGS. 19-22, or some other figure herein, may be configured to perform one or more processes, techniques, or methods as described herein, or portions thereof. One such process is depicted in FIG. 23. The process may relate to a method to be performed by a user equipment (UE), one or more elements of a UE, and/or an electronic device that includes and/or implements one or more elements of a UE. The process may include identifying, at 2301 by a low-power wake-up receiver (LP-WUR), a low-power wake-up signal (LP-WUS); and facilitating, at 2302 based on the LP-WUS, wake up for another receiver of the UE.

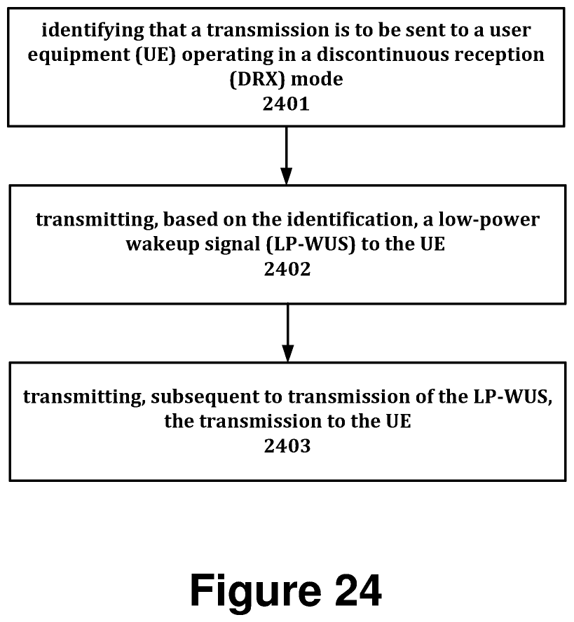

Another such process is depicted in FIG. 24. The process may be related to a method to be performed by a base station, one or more elements of a base station, and/or an electronic device that includes and/or implements one or more elements of a base station. The process may include identifying, at 2401, that a transmission is to be sent to a user equipment (UE) operating in a discontinuous reception (DRX) mode; transmitting, at 2402 based on the identification, a low-power wake-up signal (LP-WUS) to the UE; and transmitting, at 2403 subsequent to transmission of the LP-WUS, the transmission to the UE.

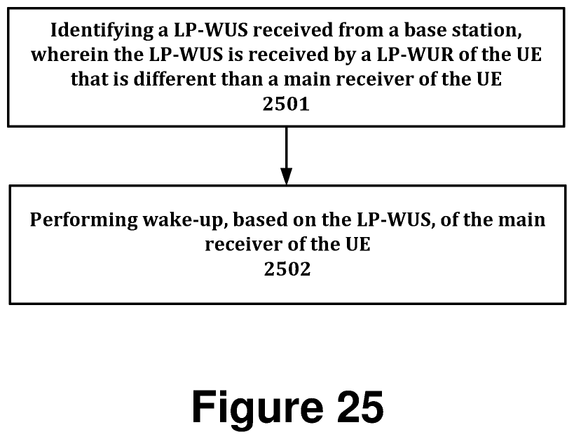

Another such process is depicted in FIG. 25. The process of FIG. 25 may include or relate to a method to be performed by a user equipment (UE), one or more elements of a UE, and/or an electronic device that includes and/or implements one or more elements of a UE. The process may include identifying, at 2501, a low-power wake-up signal (LP-WUS) received from a base station, wherein the LP-WUS is received by a low-power wake-up receiver (LP-WUR) of the UE that is different than a main receiver of the UE; and facilitating, at 2502 based on the LP-WUS, wake-up of the main receiver of the UE.

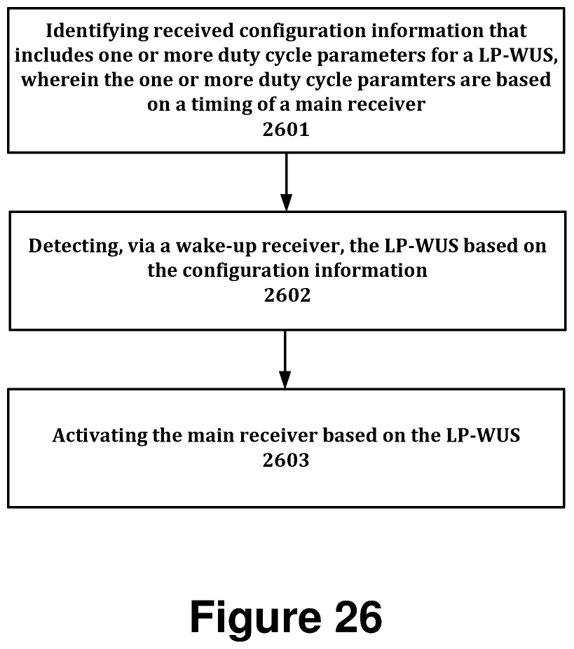

Another such process is depicted in FIG. 26. The process of FIG. 26 may include or relate to a method to be performed by a user equipment (UE), one or more elements of a UE, and/or one or more electronic devices that include and/or implement a UE. The process may include receiving, at 2601, configuration information that includes one or more duty cycle parameters for a low power wake-up signal (LP-WUS), wherein the one or more duty cycle parameters are based on a timing of a main receiver; detecting, at 2602 via a wake-up receiver, the LP-WUS based on the configuration information; and activating, at 2603, the main receiver based on the LP-WUS.

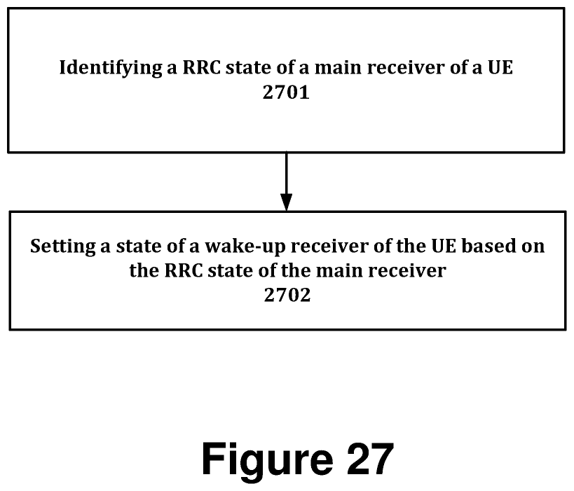

Another such process is depicted in FIG. 27. The process of FIG. 27 may include or relate to a method to be performed by a user equipment (UE), one or more elements of a UE, and/or one or more electronic devices that include and/or implement a UE. The process may include identifying, at 2701, a radio resource control (RRC) state of a main receiver of a UE; and setting, at 2702, a state of a wake-up receiver of the UE based on the RRC state of the main receiver.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1A includes a system and method to trigger the transmission using a separate low-power wake-up receiver.
Example 2A includes the system and method of example 1A, and/or some other example herein, LP-WUS support one of the following purposes: RRM measurement, triggering paging reception, trigerring SIB reception or obtaining synchronization
Example 3A may include the system and method of example 2A, and/or some other example herein, wherein UE does the RRM measurement based on only a LP-WUS that is transmitted to the UE, or a LP-WUS no matter the LP-WUS is indicated to the UE or not, or a special LP-WUS for UE to do RRM measurement based on the LP-WUS.
Example 4A may include the system and method of example 3A, and/or some other example herein, wherein the LP-WUS for RRM is transmitted by gNB periodically
Example 5A may include the system and method of example 3A, and/or some other example herein, when gNB doesn't transmit any other LP-WUS in a period, gNB transmits the LP-WUS for RRM.
Example 6A includes the system and method of example 1A, and/or some other example herein, if the RRM measurement is still valid for a UE, the UE monitors the LP-WUS to determine if the UE needs to wake up the main receiver.
Example 7A includes the system and method of example 1A, and/or some other example herein, the LP-WUS indicates the early indication of the sub-groups of paging occasions and/or the TRS availability indication
Example 8A includes the system and method of example 1A, and/or some other example herein, the LP-WUS indicates the early indication for a UE to be paged and/or the TRS availability indication
Example 9A includes the system and method of example 1A, and/or some other example herein, the LP-WUS indicates the group of UEs of a PO and/or the TRS availability indication Example 10A includes the system and method of example 1A, and/or some other example herein, the LP-WUS indicates some or all of the following information
   Paging early indication.
   TRS for idle/inactive indication,
   Other control/data reception indication
Example 11A includes the system and method of example 1A, and/or some other example herein, the LP-WUS is configured for a UE to indicate control/data reception in the next DRX ON duration for a UE
Example 12A includes the system and method of example 1A, and/or some other example herein, the LP-WUS is configured for a UE to indicate control/data reception in the next DRX ON duration for a UE, and whether to receive certain signals in DRX off period.
Example 13A includes the system and method of example 1A, and/or some other example herein, the LP-WUS is continuously monitored which indicates that control/data for the UE is to be scheduled.
Example 14A may include the system and method of example 1A and/or some other example herein, wherein the LP-WUS indicates the information on PDCCH skipping or search space set group (SSSG) switching.
Example 15A may include the system and method of example 1A and/or some other example herein, wherein the LP-WUS indicates the same or different set of information for LP-WUS in DRX OFF or in DRX ON duration.
Example 16A includes a method to be performed by a user equipment (UE), one or more elements of a UE, and/or an electronic device that includes and/or implements one or more elements of a UE, wherein the method comprises: identifying, by a low-power wake-up receiver (LP-WUR), a low-power wake-up signal (LP-WUS); and facilitating, based on the LP-WUS, wake up for another receiver of the UE.
Example 17A includes the method of example 16A, and/or some other example herein, wherein the other receiver is in a sleep mode based on discontinuous reception (DRX) operation of the UE.
Example 18A includes the method of any of examples 16A-17A, and/or some other example herein, further comprising performing, based on the LP-WUS, cell selection.
Example 19A includes the method of any of examples 16A-18A, and/or some other example herein, further comprising determining, based on the LP-WUS, paging reception.
Example 20A includes the method of any of examples 16A-19A, and/or some other example herein, further comprising determining, based on the LP-WUS, system information block (SIB) reception.
Example 21A includes the method of any of examples 16-20A, and/or some other example herein, further comprising obtaining, based on the LP-WUS, synchronization.
Example 22A includes a method to be performed by a base station, one or more elements of a base station, and/or an electronic device that includes and/or implements one or more elements of a base station, wherein the method comprises: identifying that a transmission is to be sent to a user equipment (UE) operating in a discontinuous reception (DRX) mode; transmitting, based on the identification, a low-power wake-up signal (LP-WUS) to the UE; and transmitting, subsequent to transmission of the LP-WUS, the transmission to the UE.
Example 23A includes the method of example 22A, and/or some other example herein, wherein a low-power wake-up receiver (LP-WUR) is to facilitate wake-up, based on the LP-WUS, of another receiver of the UE.
Example 24A includes the method of any of examples 22A-23A, and/or some other example herein, wherein the LP-WUS is further related to cell selection.
Example 25A includes the method of any of examples 22A-24A, and/or some other example herein, wherein the LP-WUS is further related to paging reception.
Example 26A includes the method of any of examples 22A-25A, and/or some other example herein, wherein the LP-WUS is further related to system information block (SIB) reception.
Example 27A includes the method of any of examples 22A-26A, and/or some other example herein, wherein the LP-WUS is further related to synchronization.
Example 28A includes the method of any of examples 22A-27A, and/or some other example herein, wherein the LP-WUS includes an indication that it is related to a UE, does not include an indication related that it is related to the UE, or is a special LP-WUS.
Example 29A includes the method of any of examples 22A-28A, and/or some other example herein, wherein the LP-WUS is transmitted periodically.
Example 30A includes the method of any of examples 22A-29A, and/or some other example herein, wherein the LP-WUS includes an indication related to PDCCH skipping or SSSG switching.
Example 31A includes the method of any of examples 22A-30A, and/or some other example herein, wherein the information of the LP-WUS is based on whether the UE is operating in DRX off or DRX on mode.
Example 1B may include a method for duty cycle based low-power wake-up signal transmission.
Example 2B may include the method of example 1B, and/or some other example herein, wherein the parameters for duty cycle based operation of LP-WUS is configured in accordance with the timing of the main receiver.
Example 3B may include method of example 2B, and/or some other example herein, wherein one or more of the following parameters are used
   A duty cycle period
   A start offset for LP-WUS detection in a duty cycle
   A duration in which the UE detects LP-WUS
Example 4B may include the method of example 3B, and/or some other example herein, wherein multiple duty cycle configurations are configured for a UE for LP-WUS detection.
Example 5B may include the method of example 3B, and/or some other example herein, UE expects the duty cycle of the LP-WUS is equal to the periodicity of the DRX operation of main receiver.
Example 6B may include the method of example 3B, and/or some other example herein, wherein a UE switches between two or more duty cycle configurations configured for LP-WUS detection.
Example 7B may include the method of example 1B, and/or some other example herein, wherein a UE is configured with a second set of paging occasion (PO) and if supported, the paging early indication (PEI) PDCCH that is associated with the PO.
Example 8B may include the method of example 7B, and/or some other example herein, wherein after the UE detect a LP-WUS, the UE only monitors a PO/PEI in the second set which is at least a period X after the detected LP-WUS.
Example 9B may include the method of example 7B, and/or some other example herein, after the UE detect a LP-WUS, the UE monitors a PO/PEI in the first or second set whichever is earlier, where the monitored PO/PEI in the first or second set is at least a period X after the detected LP-WUS.
Example 10B may include the method of example 1B, and/or some other example herein, wherein for a main receiver in IDLE/INACTIVE state, the time location for the detection of LP-WUS of a UE is determined referring to the first paging frame (PF) of the UE.
Example 11B may include the method of example 1B, and/or some other example herein, wherein to indicate whether a UE needs to start PDCCH monitoring from the start of next DRX ON duration, the time location for the detection of LP-WUS of the UE is determined referring to the start of next DRX ON duration.
Example 12B may include a method of a UE, the method comprising: receiving configuration information that includes one or more duty cycle parameters for a low power wake-up signal (LP-WUS), wherein the one or more duty cycle parameters are based on a timing of a main receiver; detecting, via a wake-up receiver, the LP-WUS based on the configuration information; and activating the main receiver based on the LP-WUS.
Example 13B may include method of example 12B, and/or some other example herein, wherein the one or more duty cycle parameters include one or more of:
   A duty cycle period;
   A start offset for LP-WUS detection in a duty cycle; and/or
   A duration in which the UE is to detect the LP-WUS.
Example 14B may include the method of example 12B-13B, and/or some other example herein, wherein the configuration information includes multiple duty cycle configurations for LP-WUS detection.
Example 15B may include the method of example 12B-14B, and/or some other example herein, wherein the duty cycle of the LP-WUS is equal to a periodicity of a DRX operation of the main receiver.
Example 16B may include the method of example 12B-15B, and/or some other example herein, wherein, when the main receiver is in a IDLE and/or INACTIVE state, the time location for the detection of the LP-WUS is determined based on a first paging frame (PF) of the UE.
Example 17B may include the method of example 14B, and/or some other example herein, further comprising switching between the multiple duty cycle configurations for LP-WUS detection.
Example 18B may include the method of example 12B-17B, and/or some other example herein, wherein the configuration information includes a first and second set of paging occasions (POs), and an indication of a paging early indication (PEI) PDCCH that is associated with the first or second set of POs.
Example 19B may include the method of example 18B, and/or some other example herein, further comprising, based on the detection of the LP-WUS, monitoring for a PO/PEI in the second set of POs which is at least a period X after the detected LP-WUS.
Example 20B may include the method of example 18B-19B, and/or some other example herein, further comprising, based on the detection of the LP-WUS, monitoring for a PO/PEI in an earlier of the first or second set of POs that is at least a period X after the detected LP-WUS.
Example 1C may include a method for state machine of low-power wake-up signal transmission.
Example 2C may include the method of example 1C, and/or some other example herein, wherein the LP-WUS based wake-up indication is applicable to all three RRC states (IDLE, INACTIVE, CONNECTED) of main receiver.
Example 3C may include the method of example 2C, and/or some other example herein, wherein the two states of LP-WUR are applicable for any of the three states of the main receiver.
Example 4C may include the method of example 2C, and/or some other example herein, wherein if the main receiver is in CONNECTED state, the LP-WUR is always active.
Example 5C may include the method of example 1C, and/or some other example herein, wherein the LP-WUS based wake-up indication is only applicable to IDLE/INACTIVE states of main receiver.
Example 6C may include the method of example 1C, and/or some other example herein, wherein UE selects one configuration of LP-WUS for LP-WUR according to RRC states of the main receiver.
Example 7C may include the method of example 1C, and/or some other example herein, when a timer which starts upon the UE enters certain RRC state expires, the main receiver goes to sleep.
Example 8C may include a method of a user equipment (UE), the method comprising: identifying a radio resource control (RRC) state of a main receiver of a UE; and setting a state of a wake-up receiver of the UE based on the RRC state of the main receiver.
Example 9C may include the method of example 8C, and/or some other example herein, wherein the wake-up receiver is to monitor for a low power wake-up signal (LP-WUS) when the main receiver is in an IDLE state, an INACTIVE state, and a CONNECTED state.
Example 10C may include the method of example 8C-9C, and/or some other example herein, wherein a monitoring pattern for the LP-WUS is different for the different RRC states of the main receiver.
Example 11C may include the method of example 8C-10C, and/or some other example herein, wherein a content of the LP-WUS is different for the different RRC states of the main receiver.
Example 12C may include the method of example 8C-11C, and/or some other example herein, wherein the wake-up receiver is always in an active state when the main receiver is in the CONNECTED state, and wherein the wake-up receiver switches between the active state and an inactive state when the main receiver is in the IDLE state or the INACTIVE state.
Example 13C may include the method of example 8C, and/or some other example herein, wherein the wake-up receiver is inactive when the RRC state of the main receiver is CONNECTED.
Example 14C may include the method of example 8C-13C, and/or some other example herein, further comprising determining a configuration of the LP-WUS based on the RRC state of the main receiver.
Example 15C may include the method of example 8C-14C, and/or some other example herein, further comprising: starting a timer upon the UE entering the RRC state; and transitioning the main receiver to sleep upon expiration of the timer.
Example 1D includes a method to be performed by a user equipment (UE), one or more elements of a UE, and/or an electronic device that includes and/or implements one or more elements of a UE, wherein the method comprises: identifying a low-power wake-up signal (LP-WUS) received from a base station, wherein the LP-WUS is received by a low-power wake-up receiver (LP-WUR) of the UE that is different than a main receiver of the UE; and facilitating, based on the LP-WUS, wake-up of the main receiver of the UE.
Example 2D includes the method of example 1D, and/or some other example herein, wherein the main receiver is in a sleep mode based on discontinuous reception (DRX) operation of the UE.
Example 3D includes the method of any of examples 1D-2D, and/or some other example herein, further comprising performing, by the UE via the main receiver subsequent to the wake-up of the main receiver based on the LP-WUS, cell selection.
Example 4D includes the method of any of examples 1D-3D, and/or some other example herein, further comprising performing, by the UE via the main receiver subsequent to the wake-up of the main receiver based on the LP-WUS, paging reception.
Example 5D includes the method of any of examples 1D-4D, and/or some other example herein, further comprising performing, by the UE via the main receiver subsequent to the wake-up of the main receiver based on the LP-WUS, SIB reception.
Example 6D includes the method of any of examples 1D-5D, and/or some other example herein, further comprising obtaining, by the UE via the main receiver subsequent to the wake-up of the main receiver based on the LP-WUS, downlink (DL) synchronization.
Example 7D includes the method of any of examples 1D-6D, and/or some other example herein, wherein the LP-WUS includes an indication that it is related to the UE.
Example 8D includes the method of any of examples 1D-7D, and/or some other example herein, wherein the LP-WUS is transmitted periodically by the base station.
Example 9D includes the method of any of examples 1D-8D, and/or some other example herein, wherein the LP-WUR does not have data-transmit functionality, and the main receiver has data-transmit functionality.
Example 1E includes a method to be performed by a user equipment (UE), one or more elements of a UE, and/or one or more electronic devices that include and/or implement a UE, wherein the method comprises: receiving configuration information that includes one or more duty cycle parameters for a low power wake-up signal (LP-WUS), wherein the one or more duty cycle parameters are based on a timing of a main receiver; detecting, via a wake-up receiver, the LP-WUS based on the configuration information; and activating the main receiver based on the LP-WUS.
Example 2E includes the method of example 1E, and/or some other example herein, wherein the one or more duty cycle parameters include a duty cycle period, a start offset for LP-WUS detection in a duty cycle, or a duration in which the UE is to detect the LP-WUS.
Example 3E includes the method of any of examples 1E-2E, and/or some other example herein, wherein the configuration information includes multiple duty cycle configurations for LP-WUS detection.
Example 4E includes the method of example 3E, and/or some other example herein, further comprising switching between respective ones of the multiple duty cycle configurations for LP-WUS detection.
Example 5E includes the method of any of examples 1E-4E, and/or some other example herein, wherein the duty cycle of the LP-WUS is equal to a periodicity of a DRX operation of the main receiver.
Example 6E includes the method of any of examples 1E-5E, and/or some other example herein, wherein, when the main receiver is in a radio resource control (RRC) IDLE state or a RRC INACTIVE state, a time location for the detection of the LP-WUS is based on a first paging frame (PF) of the UE.
Example 7E includes the method of any of examples 1E-6E, and/or some other example herein, wherein the configuration information includes: an indication of a first set of paging occasions (POs); an indication of a second set of POs; and an indication of a paging early indication (PEI) physical downlink control channel (PDCCH) that is associated with the first set of POs or the second set of POs.
Example 8E includes the method of example 7E, and/or some other example herein, further comprising, based on the detection of the LP-WUS, monitoring for a PO in the second set of POs which is at least a time period X after the detected LP-WUS where the value of X is determined based on: pre-configuration, configuration by higher layer signaling, or reporting by UE as UE capability.
Example 9E includes the method of example 7E, and/or some other example herein, further comprising, based on the detection of the LP-WUS, monitoring for a PO in an earlier of the first set of POs or the second set of POs that is at least a time period X after the detected LP-WUS wherein the value of X is determined based on: pre-configuration, configuration by higher layer signaling, or reporting by UE as UE capability.
Example 1F includes a method to be performed by a user equipment (UE), one or more elements of a UE, and/or one or more electronic devices that include and/or implement a UE, wherein the method comprises: identifying a radio resource control (RRC) state of a main receiver of a UE; and setting a state of a wake-up receiver of the UE based on the RRC state of the main receiver.
Example 2F includes the method of example 1F, and/or some other example herein, wherein the wake-up receiver is to monitor for a low power wake-up signal (LP-WUS) when the main receiver is in a radio resource control (RRC) IDLE state, a RRC INACTIVE state, or a RRC CONNECTED state.
Example 3F includes the method of example 2F, and/or some other example herein, wherein a monitoring pattern for the LP-WUS when the main receiver is in one of the RRC IDLE state, RRC INACTIVE state, and RRC CONNECTED state is different than a monitoring pattern for the LP-WUS when the main receiver is in another one of the RRC IDLE state, RRC INACTIVE state, and RRC CONNECTED state.
Example 4F includes the method of example 2F, and/or some other example herein, wherein content of the LP-WUS when the main receiver is in one of the RRC IDLE state, RRC INACTIVE state, and RRC CONNECTED state is different than content of the LP-WUS when the main receiver is in another one of the RRC IDLE state, RRC INACTIVE state, and RRC CONNECTED state.
Example 5F includes the method of example 2F, and/or some other example herein, wherein the wake-up receiver is always in an active state when the main receiver is in the RRC CONNECTED state, and wherein the wake-up receiver switches between the active state and an inactive state when the main receiver is in the RRC IDLE state or the RRC INACTIVE state.
Example 6F includes the method of example 2F, and/or some other example herein, wherein the wake-up receiver is inactive when the main receiver is in the RRC CONNECTED state.
Example 7F includes the method of any of examples 1F-6F, and/or some other example herein, further comprising determining a configuration of the LP-WUS based on a radio resource control (RRC) state of the main receiver.
Example Z01 may include an apparatus comprising means to perform one or more elements of a method described in or related to any of examples 1A-7F, or any other method or process described herein.
Example Z02 may include one or more non-transitory computer-readable media comprising instructions to cause an electronic device, upon execution of the instructions by one or more processors of the electronic device, to perform one or more elements of a method described in or related to any of examples 1A-7F, or any other method or process described herein.
Example Z03 may include an apparatus comprising logic, modules, or circuitry to perform one or more elements of a method described in or related to any of examples 1A-7F, or any other method or process described herein.
Example Z04 may include a method, technique, or process as described in or related to any of examples 1A-7F, or portions or parts thereof.
Example Z05 may include an apparatus comprising: one or more processors and one or more computer-readable media comprising instructions that, when executed by the one or more processors, cause the one or more processors to perform the method, techniques, or process as described in or related to any of examples 1A-7F, or portions thereof.
Example Z06 may include a signal as described in or related to any of examples 1A-7F, or portions or parts thereof.
Example Z07 may include a datagram, packet, frame, segment, protocol data unit (PDU), or message as described in or related to any of examples 1A-7F, or portions or parts thereof, or otherwise described in the present disclosure.
Example Z08 may include a signal encoded with data as described in or related to any of examples 1A-7F, or portions or parts thereof, or otherwise described in the present disclosure.
Example Z09 may include a signal encoded with a datagram, packet, frame, segment, protocol data unit (PDU), or message as described in or related to any of examples 1A-7F, or portions or parts thereof, or otherwise described in the present disclosure.
Example Z10 may include an electromagnetic signal carrying computer-readable instructions, wherein execution of the computer-readable instructions by one or more processors is to cause the one or more processors to perform the method, techniques, or process as described in or related to any of examples 1A-7F, or portions thereof.
Example Z11 may include a computer program comprising instructions, wherein execution of the program by a processing element is to cause the processing element to carry out the method, techniques, or process as described in or related to any of examples 1A-7F, or portions thereof.
Example Z12 may include a signal in a wireless network as shown and described herein.
Example Z13 may include a method of communicating in a wireless network as shown and described herein.
Example Z14 may include a system for providing wireless communication as shown and described herein.
Example Z15 may include a device for providing wireless communication as shown and described herein.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, |
| | Antenna Port, |
| | Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, |
| | Certification Authority |
| CAPEX | CAPital Expenditure |
| CBD | Candidate Beam Detection |
| CBRA | Contention Based Random Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, |
| | Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, |
| | Central Processing Unit |
| C/R | Command/Response field bit |
| CRAN | Cloud Radio Access Network, |
| | Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, |
| | Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, |
| | extended CCA |
| ECCE | Enhanced Control Channel Element, |
| | Enhanced CCE |
| ED | Energy Detection |
| EDGE | Enhanced Datarates for GSM Evolution |
| | (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, |
| | enhanced LAA |
| EM | Element Manager |
| eMBB | Enhanced Mobile Broadband |
| EMS | Element Management System |
| eNB | evolved NodeB, |
| | E-UTRAN Node B |
| EN-DC | E-UTRA-NR Dual Connectivity |
| EPC | Evolved Packet Core |
| EPDCCH | enhanced PDCCH, |
| | enhanced Physical Downlink Control Cannel |
| EPRE | Energy per resource element |
| EPS | Evolved Packet System |
| EREG | enhanced REG, |
| | enhanced resource element groups |
| ETSI | European Telecommunications Standards Institute |
| ETWS | Earthquake and Tsunami Warning System |
| eUICC | embedded UICC, |
| | embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, |
| | GSM EDGE Radio Access Network |
| GGSN | Gateway GPRS Support Node |
| GLONASS | GLObal'naya NAvigatsionnay a Sputnikovaya |
| | Sistema (Engl.: Global Navigation Satellite System) |
| gNB | Next Generation NodeB |
| gNB-CU | gNB-centralized unit, |
| | Next Generation NodeB centralized unit |
| gNB-DU | gNB-distributed unit, |
| | Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, |
| | Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, |
| | identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, |
| | Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, |
| | Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |
| | Constraint length of the convolutional code, |
| | USIM Individual key |
| kB | Kilobyte (1000 90 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, |
| | Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, |
| | Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, |
| | MCH Scheduling Information |
| MSID | Mobile Station Identifier |
| MSIN | Mobile Station Identification Number |
| MSISDN | Mobile Subscriber ISDN Number |
| MT | Mobile Terminated, |
| | Mobile Termination |
| MTC | Machine-Type Communications |
| mMTCmassive | MTC, |
| | massive Machine-Type Communications |
| MU-MIMO | Multi User MIMO |
| MWUS | MTC wake-up signal, |
| | MTC WUS |
| NACK | Negative Acknowledgement |
| NAI | Network Access Identifier |
| NAS | Non-Access Stratum, |
| | Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, |
| | Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, |
| | Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, |
| | Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, |
| | Personal Computer |
| PCC | Primary Component Carrier, |
| | Primary CC |
| P-CSCF | Proxy CSCF |
| PCell | Primary Cell |
| PCI | Physical Cell ID, |
| | Physical Cell Identity |
| PCEF | Policy and Charging Enforcement |
| | Function |
| PCF | Policy Control Function |
| PCRF | Policy Control and Charging Rules |
| | Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, |
| | Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, |
| | Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSFCH | physical sidelink feedback channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, |
| | QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, |
| | Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, |
| | Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, |
| | Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, |
| | Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, |
| | Receiving, |
| | Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, |
| | Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, |
| | SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, |
| | Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block SSBRI SS/PBCH |
| | Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise |
| | and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, |
| | Technical Standard |
| TTI | Transmission Time Interval |
| Tx | Transmission, |
| | Transmitting, |
| | Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V21 | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, |
| | Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, |
| | Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-25. (canceled)

26. An apparatus for use in a user equipment (UE), wherein the apparatus comprises:
a memory to store a low-power wake-up signal (LP-WUS) received from a base station, wherein the LP-WUS is received by a low-power wake-up receiver (LP-WUR) of the UE that is different than a main receiver of the UE; and
one or more processors to wake-up, based on the LP-WUS, the main receiver of the UE.

27. The apparatus of claim 26, wherein the main receiver is in a sleep mode based on discontinuous reception (DRX) operation of the UE.

28. The apparatus of claim 26, wherein the one or more processors are further to facilitate, via the main receiver subsequent to the wake-up of the main receiver based on the LP-WUS, cell selection.

29. The apparatus of claim 26, wherein the one or more processors are further to facilitate, via the main receiver subsequent to the wake-up of the main receiver based on the LP-WUS, paging reception.

30. The apparatus of claim 26, wherein the one or more processors are further to facilitate, via the main receiver subsequent to the wake-up of the main receiver based on the LP-WUS, SIB reception.

31. The apparatus of claim 26, wherein the one or more processors are further to facilitate, via the main receiver subsequent to the wake-up of the main receiver based on the LP-WUS, downlink (DL) synchronization.

32. One or more non-transitory computer-readable media (NTCRM) comprising instructions that, upon execution of the instructions by one or more processors of a user equipment (UE), are to cause the UE to:
identify received configuration information that includes one or more duty cycle parameters for a low power wake-up signal (LP-WUS), wherein the one or more duty cycle parameters are based on a timing of a main receiver;
detect, via a wake-up receiver, the LP-WUS based on the configuration information; and
activate the main receiver based on the LP-WUS.

33. The one or more NTCRM of claim 32, wherein the one or more duty cycle parameters include a duty cycle period, a start offset for LP-WUS detection in a duty cycle, or a duration in which the UE is to detect the LP-WUS.

34. The one or more NTCRM of claim 32, wherein the configuration information includes multiple duty cycle configurations for LP-WUS detection.

35. The one or more NTCRM of claim 32, wherein the duty cycle of the LP-WUS is equal to a periodicity of a DRX operation of the main receiver.

36. The one or more NTCRM of claim 32, wherein, when the main receiver is in a radio resource control (RRC) IDLE state or a RRC INACTIVE state, a time location for the detection of the LP-WUS is based on a first paging frame (PF) of the UE.

37. The one or more NTCRM of claim 32, wherein the configuration information includes:
an indication of a first set of paging occasions (POs);
an indication of a second set of POs; and
an indication of a paging early indication (PEI) physical downlink control channel (PDCCH) that is associated with the first set of POs or the second set of POs.

38. The one or more NTCRM of claim 37, wherein the instructions are further to cause the UE to monitor, based on the detection of the LP-WUS, for a PO in the second set of POs which is at least a time period X after the detected LP-WUS where the value of X is determined based on: pre-configuration, configuration by higher layer signaling, or reporting by UE as UE capability.

39. The one or more NTCRM of claim 37, wherein the instructions are further to cause the UE to monitor, based on the detection of the LP-WUS, for a PO in an earlier of the first set of POs or the second set of POs that is at least a time period X after the detected LP-WUS where the value of X is determined based on: pre-configuration specification, configuration by higher layer signaling, or reporting by UE as UE capability.

40. A user equipment (UE) comprising:
a main receiver configured for wireless data transmit and reception functionality;
a wake-up receiver configured for wireless data reception functionality, wherein the wake-up receiver does not have wireless data transmit functionality; and
one or more processors coupled with the main receiver and the wake-up receiver, wherein the one or more processors are configured to:
identify a radio resource control (RRC) state of the main receiver of a UE; and
set a state of the wake-up receiver of the UE based on the RRC state of the main receiver.

51. The UE of claim 50, wherein the wake-up receiver is to monitor for a low power wake-up signal (LP-WUS) when the main receiver is in a radio resource control (RRC) IDLE state, a RRC INACTIVE state, or a RRC CONNECTED state.

52. The UE of claim 51, wherein a monitoring pattern for the LP-WUS when the main receiver is in one of the RRC IDLE state, RRC INACTIVE state, and RRC CONNECTED state is different than a monitoring pattern for the LP-WUS when the main receiver is in another one of the RRC IDLE state, RRC INACTIVE state, and RRC CONNECTED state.

53. The UE of claim 51, wherein content of the LP-WUS when the main receiver is in one of the RRC IDLE state, RRC INACTIVE state, and RRC CONNECTED state is different than content of the LP-WUS when the main receiver is in another one of the RRC IDLE state, RRC INACTIVE state, and RRC CONNECTED state.

54. The UE of claim 51, wherein the wake-up receiver is always in an active state when the main receiver is in the RRC CONNECTED state, and wherein the wake-up receiver switches between the active state and an inactive state when the main receiver is in the RRC IDLE state or the RRC INACTIVE state.

55. The UE of claim 51, wherein the wake-up receiver is inactive when the main receiver is in the RRC CONNECTED state.
